(19) United States
(12) Patent Application Publication
(10) Pub. No.: US 2024/0140629 A1
(43) Pub. Date: May 2, 2024

(54) AUTONOMOUS VEHICLE DELIVERY SYSTEM

(71) Applicant: ZIPLINE INTERNATIONAL INC., South San Francisco, CA (US)

(72) Inventors: Brian Boomgaard, South San Francisco, CA (US); Zoltan Laszlo, South San Francisco, CA (US); Keenan A. Wyrobek, South San Francisco, CA (US)

(21) Appl. No.: 18/278,285

(22) PCT Filed: Feb. 23, 2022
(86) PCT No.: PCT/US2022/017585

§ 371 Date: Aug. 22, 2023

Related U.S. Application Data
(60) Provisional application No. 63/153,203, filed on Feb. 24, 2021.

(51) Int. Cl. B64U 70/20; B64D 1/08; B64D 1/22; B64U 10/60; B64U 30/297; B64U 80/82; G05D 1/667; G05D 1/678; B64U 101/64; B64U 101/67; G05D 105/20; G05D 109/20

(52) U.S. Cl. CPC B64U 70/20; B64D 1/08; B64D 1/22; B64U 10/60; B64U 30/297; B64U 80/82; G05D 1/667; G05D 1/678; B64U 2101/64; B64U 2101/67; G05D 2105/20; G05D 2109/20

(57) ABSTRACT

An autonomous vehicle (AV) delivery system is configured to deliver a payload or package in a rural and/or urban environment. The AV delivery system includes a first autonomous vehicle (AV). The first AV is configured to travel between a payload receiving location and a payload drop location. The AV delivery system further includes a second autonomous vehicle (AV) coupled to the first AV. The second AV is coupled to a payload and configured to travel between the first AV and a designated drop target adjacent to a ground or receiving surface at the payload drop location.

### CROSS-REFERENCE TO RELATED APPLICATION

This application claims priority to U.S. Provisional Patent Application No. 63/153,203 filed Feb. 24, 2021, entitled “Autonomous Vehicle Delivery System,” the contents of which are incorporated herein by reference in the entirety and for all purposes.

### FIELD

The described embodiments relate generally to autonomous vehicles, including unmanned aerial vehicle delivery systems configured to deliver a payload or package in a rural or urban environment.

### BACKGROUND

Autonomous vehicles (AVs) are increasing in popularity for various applications. For example, AVs, such as unmanned aerial vehicles, are prevalent among hobbyists and enthusiasts for recreation, and are increasingly considered as viable package delivery vehicles. AVs take many forms, such as rotorcraft (e.g., helicopters, quadrotors, and so on) as well as fixed-wing aircraft. AVs may also be configured for different degrees of autonomy and may have varying complexity. For example, simple AVs have only basic avionics and may be controllable only by a human-operated remote control. More complex AVs may be configured with sophisticated avionics and advanced computers, and may be configured for fully autonomous and/or semi-autonomous flight.

### SUMMARY

An autonomous vehicle delivery system configured to deliver a payload or package in a rural or urban environment is shown and described.

In one example, an autonomous vehicle delivery (AV) system is disclosed and includes a first autonomous vehicle (AV). The first AV is configured to travel between a payload receiving location and a payload drop location. The AV system further includes a second autonomous vehicle (AV) coupled to the first AV. The second AV may be coupled to a payload and configured to travel between the first AV and a designated drop target adjacent to a ground or receiving surface at the payload drop location.

In another example, the first AV may be configured to release the second AV at the payload drop location. The AV delivery system may further include a retraction assembly configured to return the second AV to the first AV. The retraction assembly may include a tether extending between the first AV and the second AV. The retraction assembly may further include a winch mechanism coupled to the tether and associated with the first AV or the second AV. The winch mechanism may be configured to manipulate the tether and move the second AV and the first AV relative to one another. The retraction assembly may further include a tether attachment feature configured to fix an end of the tether to the first AV or the second AV. In some cases, an orientation of the second AV may be controlled by moving the tether relative to a body of the second AV.

In another example, the second AV includes a control feature configured to control movement of the second AV upon release from the first AV including controlling an orientation or position of the second AV relative to the first AV. The control feature may include a rotating component. The rotating component may be configured to influence angular momentum of the second AV during the travel between the first AV and the designated drop target. The rotating component may be fixed relative to a body of the second AV, the rotating component comprising differential thrusters or inertia wheels. Additionally or alternatively, one or more control features may be fixed relative to a body of the second AV.

In another example, the control feature may be articulable relative to a body of the second AV. The control feature may include active thrusters of open or ducted fan configurations, enclosed air impeller or a compressed gas thrusters. In some cases, a landing position of the second AV is controlled in part by modulating a position of the first AV in tandem with motion of the second AV.

In another example, the second AV may be coupled to a package, the package including the payload. The second AV may include a release assembly. The release assembly may be configured to, in a first configuration, hold the package and secure the package with the second AV. The release assembly may be further configured to, in a second configuration, cause a disassociation of the package and the second AV at the designated drop target.

In another example, the first AV includes a plurality of deployable members configured to expand with release from a portion of the AV during a hovering operation. The plurality of deployable members may be configured to cause a controlled descent of the AV from the hovering operation. In some cases, the first AV may further include a fabric portion coupled with the plurality of deployable members to define a canopy shape or aerodynamic maneuvering surfaces configured to cause the controlled descent of the AV from the hovering operation.

In another example, the first AV may include a propulsion system coupled with the first AV and comprising a plurality of fixed rotor assemblies and a plurality of tilt rotor assemblies, each tilt rotor assembly of the plurality of tilt rotor assemblies being configured to transition between: (i) a first configuration in which the tilt rotor assembly has a first orientation to induce a forward flight of the AV, and (ii) a second configuration in which the tilt rotor assembly has a second orientation to induce a hover of the AV. A plurality of rotor assemblies may be optimized for multipoint performance including a hovering axial flow, a transition edgewise flow, and reducing cruise drag in a stowed location. Additionally or alternatively, a plurality of rotor assemblies may be optimized for axial flow in hover and forward flight performance, including the rotor planform, twist distribution, and airfoil selection.

In another example, the AV delivery system may further include an autonomous vehicle (AV) station. The AV station may be configured to dock the first AV above grade and charge one or more electrical components of the AV. The AV station may be configured to permit lowering of the second AV to allow loading of a payload through manual or automated means. In some cases, the second AV may be configured to dock with the AV station while the first AV hovers and the first AV is pulled in to a docking position relative to the AV station.

In another example, the AV delivery system may further include a staging device. The staging device may include a plurality of bins configured to receive items for transportation by the first AV and determine whether the items satisfy a threshold criteria indicative of an acceptable payload size.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts an example environment for an autonomous vehicle delivery system;

FIGS. 2A-2D depict an example autonomous vehicle delivery system, including a first autonomous vehicle coupled to a second autonomous vehicle;

FIGS. 3A-3W depict example first or carrier autonomous vehicles of the system of FIGS. 2A-2D;

FIG. 4A-4C depict example rotor assemblies that may be used with any of the first autonomous vehicles of FIGS. 3A-3W;

FIG. 5A-5C depict example recovery mechanisms that may be used with any of the first autonomous vehicles of FIGS. 3A-3W;

FIGS. 6A-6F depict example second or ancillary autonomous vehicle of the system of FIGS. 2A-2D;

FIGS. 7A-9D depict further example second autonomous vehicle of the system of FIGS. 2A-2D;

FIGS. 10A-10C depict further example second autonomous vehicle of the system of FIGS. 2A-2D;

FIGS. 11A-11B depict further example second autonomous vehicle of the system of FIGS. 2A-2D;

FIGS. 12A-12AN depict further example second autonomous vehicle of the system of FIGS. 2A-2D;

FIGS. 13A-13I depict example propellers and sensors of any of the second autonomous vehicles of shown herein;

FIG. 14 depicts an example airfoil;

FIGS. 15A-15I depict example tether attachment features;

FIGS. 16A and 16B depict a container configuration of any of the second autonomous vehicles shown herein;

FIGS. 17A-17L depict example packages of the autonomous vehicle delivery system;

FIGS. 18A-18C depict example implementations of the autonomous vehicle delivery system with an existing facility;

FIGS. 19A-19C depict an example staging system for preparing a payload for delivery by the autonomous vehicle delivery system; and

FIGS. 20A-20J depict an example operation of the autonomous vehicle delivery system.

### DETAILED DESCRIPTION

The description that follows includes example systems, methods, and apparatuses that embody various elements of the present disclosure. However, it should be understood that the described disclosure may be practiced in a variety of forms in addition to those described herein.

The examples described herein are generally directed to autonomous vehicles (AVs) and delivery systems that use AVs. The autonomous vehicle (AV) delivery system is configured to pick up a payload or a package at a shipping location and deliver a payload or package in a rural and/or urban environment.

An example AV delivery system may include a first or carrier AV and a second or ancillary AV. The first AV may be configured to travel between a payload receiving location and a payload drop location. The payload receiving location may include a retail, wholesale, industrial, or other site in which payloads and packages are processed for delivery to a customer, including consumers. The payload drop location may include an area or physical location in which the payload or package is delivered, including without a limitation, a residential or commercial address. The first AV may be further configured to carry or hold the second AV. In this regard, the first AV may cause the second AV to travel between the payload receiving location and the payload drop location. The first AV may be configured to release the second AV at a designated drop target adjacent to a ground or receiving surface at the payload drop location. The second AV may be coupled to a payload or package and configured to travel between the first AV and the designated drop target. At the designated drop target, the second AV may release the payload or package for subsequent retrieval by the customer.

The term “autonomous vehicle” or “AV” is used herein to include unmanned aerial vehicles (UAVs), unmanned ground vehicles (UGVs), and/or any other types of vehicles that are generally operated in an autonomous or semi-autonomous manner. In this regard, the first AV and the second AV may be unmanned aerial vehicles. For example, the first AV and/or the second AV may include rotorcraft (e.g., helicopters, quadrotors, and so on) as well as fixed-wing aircraft. In other cases, at least one of the first or second AVs may be an UGV vehicle or other type of vehicle or device that is used to transport or move an object. For example, at least one of the first AV or the second AV may include wheels, legs, tracks or the like to facilitate movement relative to a ground surface. In some cases, the first or second AV may be capable of both aerial and ground movement. Additionally, the second or ancillary AV may be a passive load, as described herein, slung from the first or carrier AV. It will therefore be appreciated, that while the first AV and the second AV are shown in the context of an aerial vehicle system, this is for purposes of illustration, and other configurations are possible without departing from the disclosure.

To facilitate the foregoing, the first or carrier AV may include a propulsion system that allows the first AV to travel between the payload receiving location and the payload drop location. In one example, the propulsion system includes at least one fixed rotor assembly and at least one tilt rotor assembly. The fixed rotor assembly may include a first airfoil that is oriented in a manner to facilitate a forward flight of the AV. The tilt rotor assembly may include a second airfoil that can be adapted for or manipulated between a first orientation to induce a forward flight of the AV, and a second orientation to induce a hover of the AV. While many configurations are possible and illustrated herein, the first or carrier AV may include a plurality of fixed rotor assemblies, such as four fixed rotor assemblies, and a plurality of tilt rotor assemblies, such as two tilt rotor assemblies, which may provide a fault tolerance in both the hover and forward flight. A subset of the rotor assemblies may be optimized via multipoint objective optimization for axial flow in hover and forward flight performance, including the rotor planform, twist distribution, and airfoil selection. The rotors can also include folding rotors configured to reduce drag in forward flight for single rotor operation. The remaining rotors may be optimized for multipoint performance covering both hovering axial and transitioning edgewise flow, along with reducing cruise drag in a stowed location.

The first AV may include a recovery system that allows the first AV to return to the ground in a controlled manner in the event of an emergency, mechanical or electrical failure, and the like. The recovery system may be configured to allow the first AV to return to the ground in a controlled manner from the hover configuration, or otherwise in a configuration in which forward movement of the first AV is zero or near zero. To facilitate the foregoing, the recovery system may include a plurality of deployable members that are configured to expand with release from a portion of the first AV. Broadly, the deployable members may be configured to expand with release from a portion of the AV during a hovering operation and cause a controlled descent of the AV from the hovering operation. Energy arresting schemes including airbags and streamers are also contemplated. In one example, the deployable members may be inflatable tubes that are rapidly inflated with the aid of a pyrotechnic device. The recovery system may further include a fabric portion coupled with the plurality of deployable members to define a canopy shape or aerodynamic maneuvering surface that is configured to cause a controlled descent of the first AV from the hovering operation.

At the payload drop location, the first AV may cause the second or ancillary AV to be released for delivery of the payload to the designated drop target. The second or ancillary AV may be coupled to the first AV via a retraction assembly. The retraction assembly may include a winch mechanism coupled to the first AV and a tether that can be manipulated by the winch mechanism and coupled to the second AV. Upon release, the second AV may separate from the first AV and descend toward the designated drop target, extending the tether. The second AV may include a variety of systems and assemblies to control the orientation, position, rate of travel and the like of the second AV during the travel between the first AV and the designated drop target.

For example, in some cases, the second AV may include one or more control features. The control feature may be configured to broadly control movement of the second AV, including controlling a position or orientation of the second AV relative to the first AV. Sample control features include, without limitation, an inertia wheel, a fan, aerodynamic surfaces (which may or may not be passive), and so on. In this regard, the control feature may include a rotating component that is configured to influence angular momentum of the second AV. In some cases, the control feature may have rotating components that are substantially fixed, such as may be the case for a differential thruster or inertia wheel. Additionally or alternatively, the one or more control features may be articulable relative to a body of the second of the AV, including articulable active thrusters of open ducted fan configurations, enclosed air impellers, compressed gas thrusters, and so on. Broadly, the control features may operate to stabilize the second AV during the travel to the designated drop target, including maintaining the second AV substantially level relative to a group surface and/or reducing spinning of the second AV. This may allow the second AV to deliver the payload to the designated drop target in a controlled manner with minimal disturbance to the contents of the package.

The second AV may be configured to release the payload at the designated drop target. The second AV may include a payload release assembly that may operate to secure the payload to the second AV during travel. The payload release assembly may include an articulable release feature, such as a door, clip, latch, and so on that is operable to dissociate the payload from the second AV at the appropriate time. The payload may be or include a packaging that is configured for coupling with the payload release assembly. For example, the packaging may include a payload coupling feature, such as a tab, notch, ring, or other feature that is securable to the payload release assembly. In other cases, the payload may be received by the second AV, such as may be the case for any of the second AV container configurations described herein.

The AV systems described herein may be adapted to small, medium, and large-scale integration with existing infrastructure. Existing infrastructure may include, without limitation, retail, wholesale, industrial locations, and so on. More generally, existing infrastructure may include any location at which packages may be processed for delivery to a customer. To facilitate the foregoing, the AV systems described herein may include an autonomous vehicle (AV) station. The AV station may be located at the payload receiving location and may be configured to store the first or carrier AV and prepare the first AV for travel to the payload drop location. For example, the AV station may be configured to dock the first AV above grade and charge one or more electrical components of the first AV. The AV station may include a raised platform with a through portion. The through portion may allow the second or ancillary AV to be lowered to a working height at which a payload is coupled to the second AV. The second AV may return to the first AV through the through portion. The first AV may take off and land on the raised platform. The AV station may be part of a modular system, in which multiple AV stations may be associated with one another based on the scale of the integration. Additionally or alternatively, the AV station may be a mobile installation and readily transportable between existing infrastructure, such as may be the case where the AV station is associated with a semi-tractor trailer or other mobile installation.

The AV system may also include a staging device to facilitate the loading of second AV with the payload. In one example, a staging device may include a plurality of bins that are configured to receive items for transportation by the system. The bins may be configured to determine whether the received items satisfy a threshold criteria indicative of an acceptable payload. For example, the bins may have a volume that corresponds to a maximum acceptable volume for transportation by the system. Further, the bins may be associated with a sensor that is configured to determine whether the weight of items placed in the bin is below a maximum acceptable weight for transportation by the system. In some cases, the bin may include or define a portion of the second AV, such as a container portion. In the regard, upon filling the bin with items, a used may remove the bin from the staging device and associate the bin or container with the main portion or body of the second AV. The second AV may be subsequently associated with the first AV for delivery to the designated drop target. In this regard, the bins or containers may be interchangeable and reusable throughout the system.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

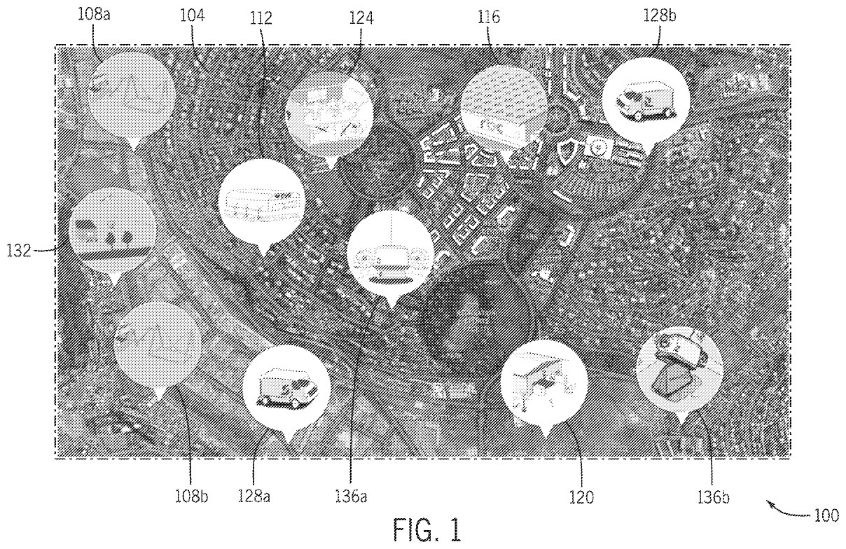

FIG. 1 depicts an example system 100 for an autonomous vehicle delivery system, such as the system discussed above and described in greater detail below. The system 100 may include an urban or rural environment 104. The system 100 may operate to deliver payloads or packages throughout the environment 104 using one or more autonomous vehicles, such as any of the AVs described herein. The system 100 may incorporate multiple different types of AVs in order to deliver payloads throughout the environment 104 from a variety of different infrastructure locations. For example, FIG. 1 shows long-range bases 108a, 108b. The long-range bases 108a, 108b may be in a location at which an AV is launched for delivery of a payload or package to a more remote location, including a rural location or other location outside of a city center. As such, the long-range bases may be suited to launch and land AVs that are adapted to travel longer ranges, such as at least 10 miles, at least 30 miles, at least 50 miles, or more, and return to the long-range bases 108a, 108b.

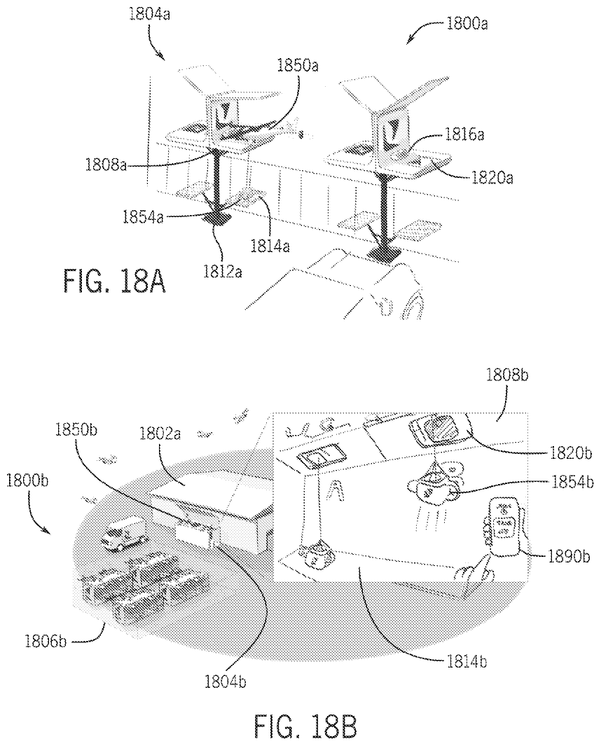

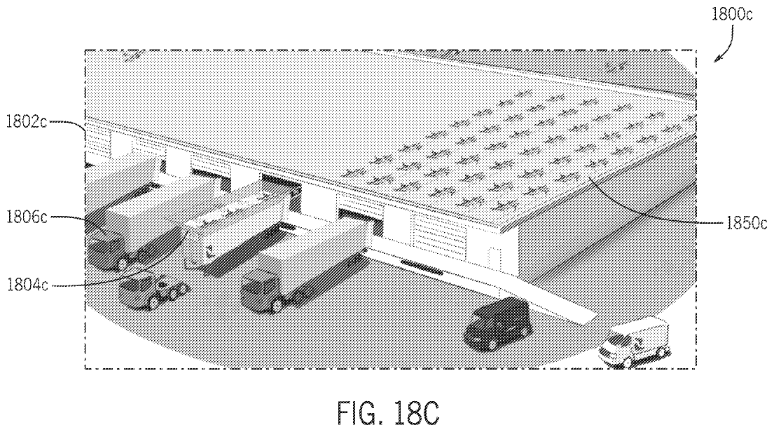

As another example, the system includes local bases 112, 116, 120. The local bases may be a location at which AVs are launched for delivery of a payload to a location within the environment 104, such as generally a location that is at a lesser distance than the target travel location of AVs stationed at the long-range bases 108a, 108b. The local bases 112, 116, 120 may be modular stations that are integrated with existing infrastructure. For example, the local bases 112, 116, 120 may be co-located with small, medium, or large-scale existing infrastructure, as shown in the examples of FIGS. 18A-18C herein.

The AVs of the system 100 may travel from the respective bases to an example drop location 132, such as a residential location. At the drop location 132, the AV may initiate a release operation 136a, 136b in order to leave the payload at the drop location 132 or other respective location. Remote control and monitoring of the AVs of the system may be accomplished at a control center 124. The remote control center 124 may facilitate one or more of the following functions: service requests, package pickup, package delivery, data capture, mapping, surveillance, launch, recharge, recovery, communications, repair, and/or payload logistics. Additionally or alternatively, one or more of the foregoing functions may be performed at the respective bases 108a 108b, 112, 116, 120. FIG. 1 further shows maintenance operators 128a, 128b, which may include operations associated with travel to one or more bases to repair and update AVs as needed.

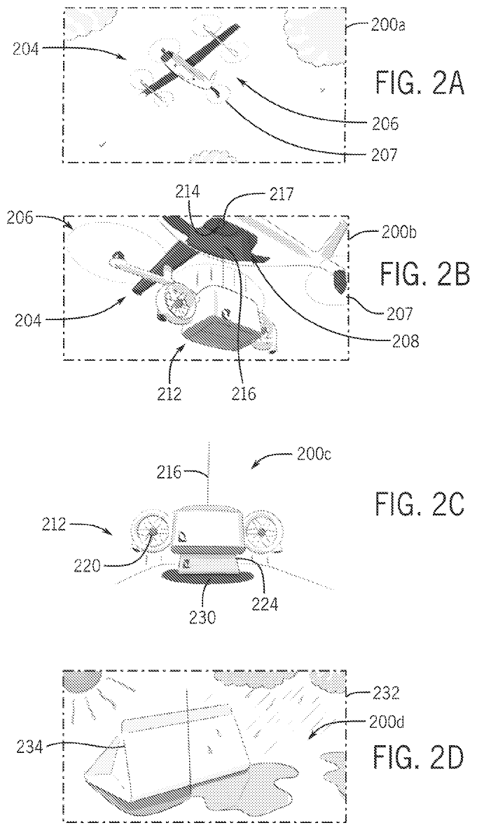

FIGS. 2A-2D depict example operations of one or more AVs in the system 100 of FIG. 1. With respect to FIG. 2A, an operation 200a is shown in which a first or carrier AV 204 is in transit from a payload receiving location (e.g., local bases 112, 116, 120) to the payload drop location (e.g., drop location 132). The carrier AV 204 includes a propulsion system 206 that induces the forward travel of the carrier AV 204. For example, the propulsion system 206 includes one or more rotor assemblies 207 that are in a first configuration or orientation in FIG. 2A that is optimized for the forward travel of the carrier AV 204.

With respect to FIG. 2B, an operation 200b is shown in which the carrier AV 204 releases a second or ancillary AV 212. The ancillary AV 212 may be held substantially within the carrier AV 204 and released from the carrier AV 204 via a release assembly 208. The first AV 204 may include a retraction assembly 214 including a winch mechanism 217 and a tether 216. The winch mechanism 217 may be coupled to the tether 216 and associated with the carrier AV 204 or the ancillary AV 212. The winch mechanism 217 may be configured to manipulate the tether 216 and move the ancillary AV 212 relative to the carrier AV 204. For example, the winch mechanism 217 and/or other mechanism of the retraction assembly 214 may be configured to wind the tether 216 and raise the ancillary AV 212 toward and/or into the carrier AV 204. In some cases, an orientation or position of the ancillary AV 212 may be controlled by moving the tether 214. Additionally or alternatively, the ancillary AV 212 position (including a landing position) may be controlled using inertia of the ancillary AV 212 in a dynamic motion by modulating a position of the carrier AV 204 in tandem with the motion of the ancillary AV 212. In the operation 200b, the propulsion system 206 of the carrier AV 204 may induce a hover of the carrier AV 204, or otherwise substantially curtail or momentarily prevent forward travel, during the release of the ancillary AV 212. To facilitate the foregoing, the one or more of the rotor assemblies 207 may rotate in or to a second configuration or orientation that is optimized for the hovering of the carrier AV 204, as shown in FIG. 2B.

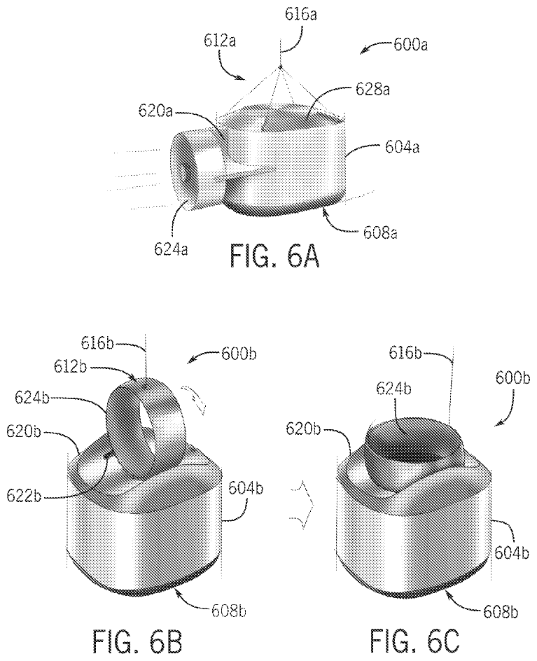

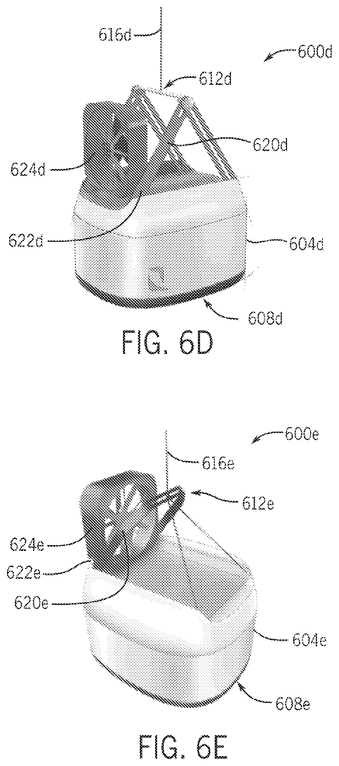

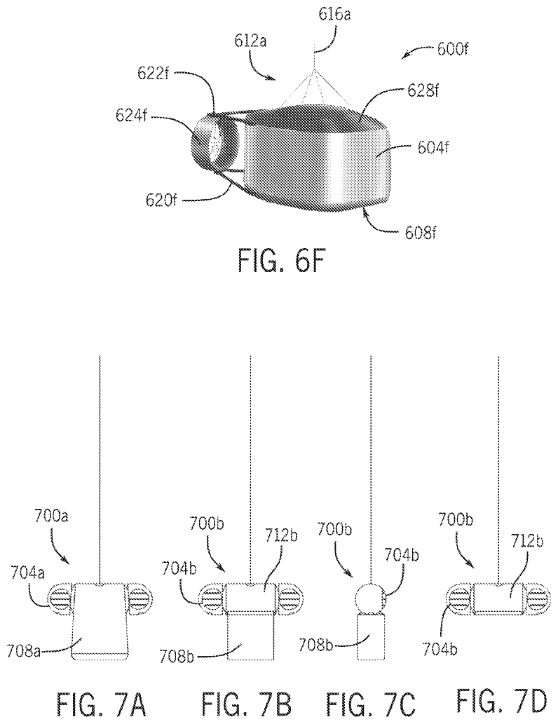

With respect to FIG. 2C, an operation 200c is shown in which the ancillary AV 212 releases a payload 224 at designated drop target 230. The ancillary AV 212 is shown with one or more control features 220. The control features 220 may be configured to control one or more of an orientation, position, and rate of travel of the ancillary AV 212. Example control features may include inertia wheels, fans, and aerodynamic surfaces, and so on, as show in greater detail with respect to FIGS. 6A-12AN. With respect to FIG. 2D, an operation 200d is shown in which the payload 224 is disassociated from the ancillary AV 212 for subsequent retrieval by a customer. The payload 242 may be packaged in a manner to shield internal contents from an environment 232, including adverse weather conditions.

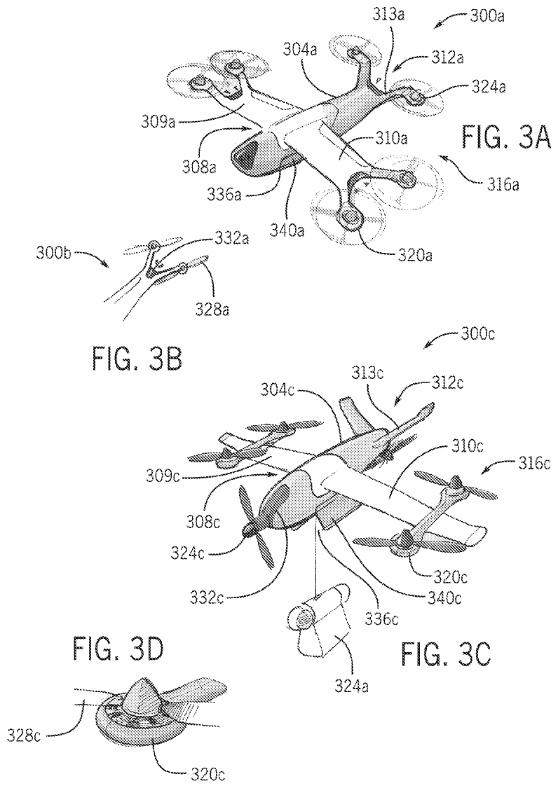

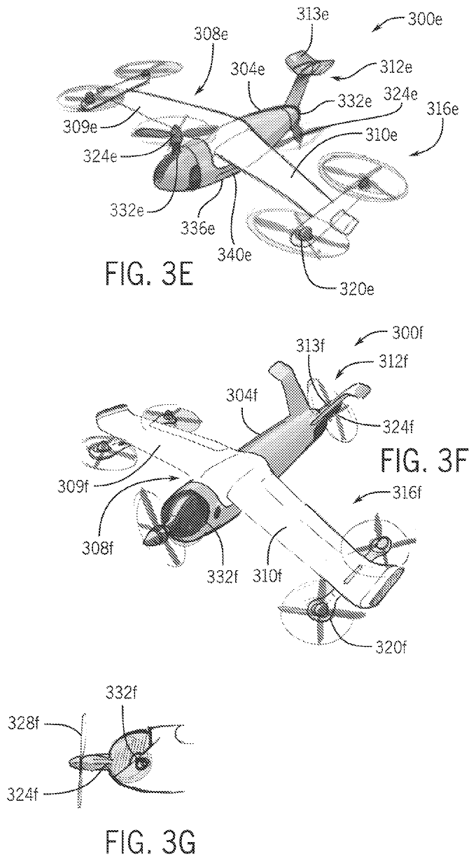

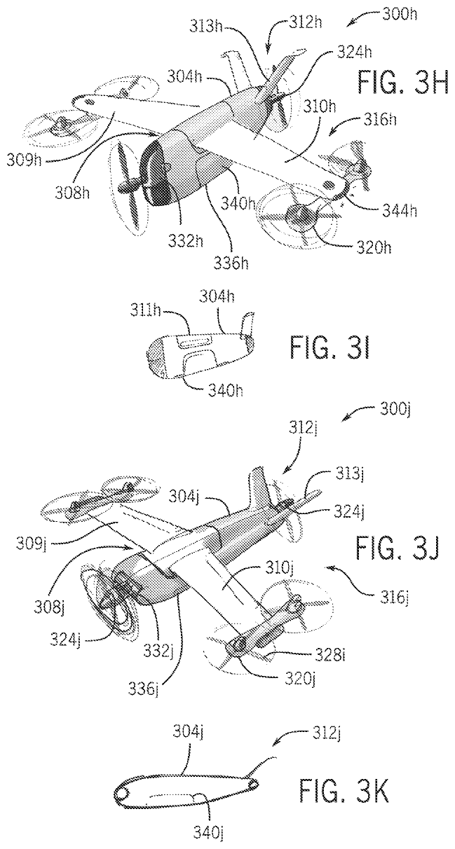

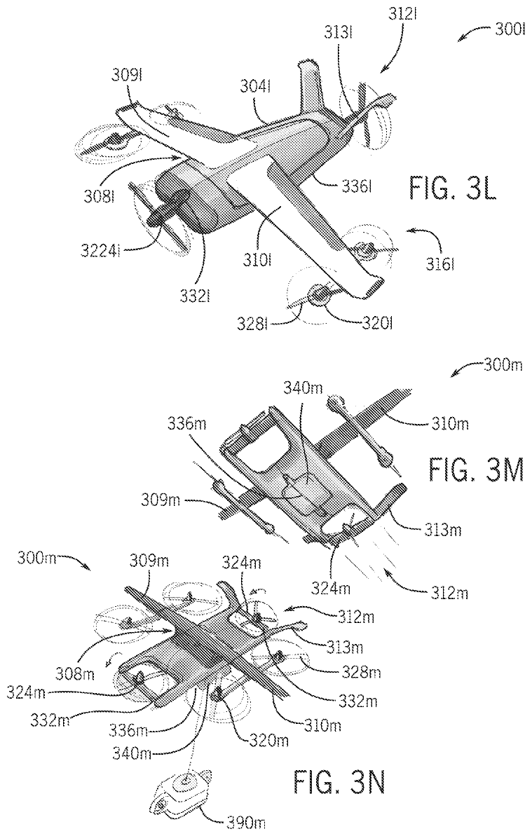

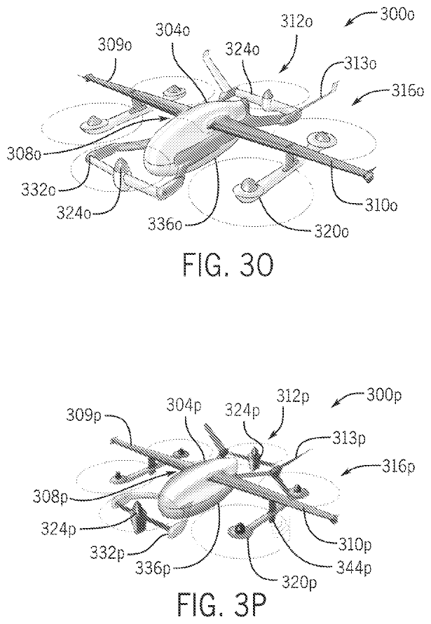

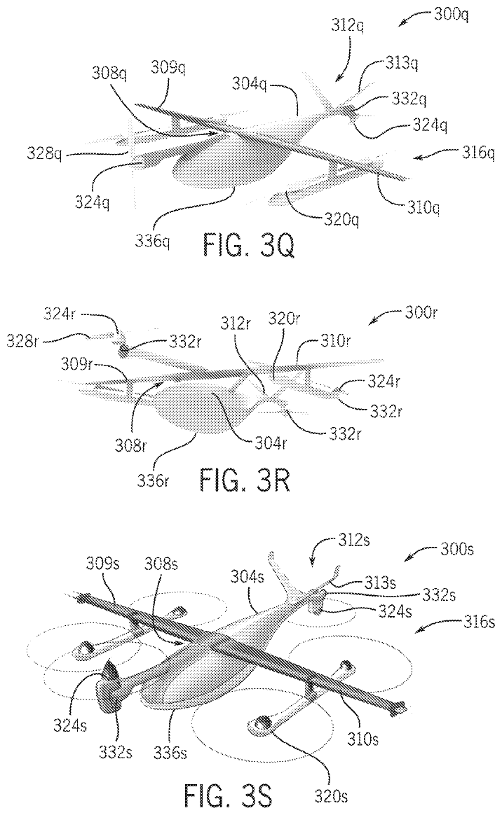

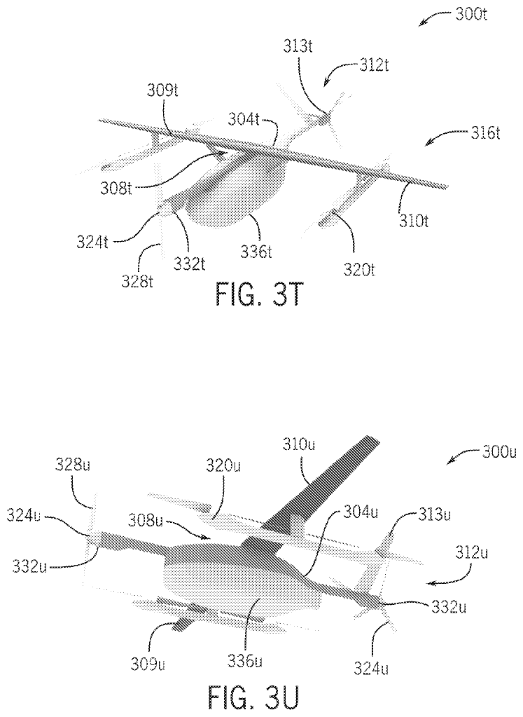

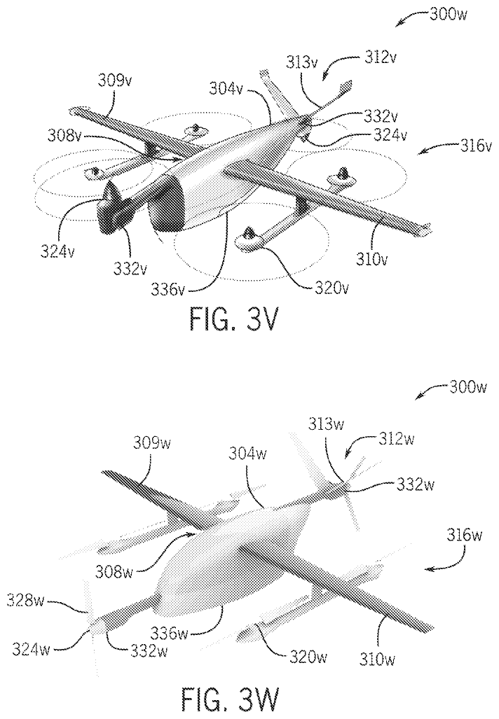

FIGS. 3A-3W depict example implementations of a first or carrier autonomous vehicle 204 of the system 100. For example, FIGS. 3A and 3B depict an example carrier autonomous vehicle (AV) 300a. The carrier AV 300a may be substantially analogous to any of the carrier AVs or first AVs or the like, described herein, such as the carrier AV 204 of FIGS. 2A-2D. In this regard, the carrier AV 300a may be configured to hold an ancillary AV, including a payload, and travel between a payload receiving location and a payload drop location. The carrier AV 300a may be further configured to release the ancillary AV and payload at the payload drop location for delivery of the payload at a designated drop target.

In the example of FIGS. 3A and 3B, the carrier AV 300a may include a fuselage 304a and wing assembly 308a. The wing assembly 308a may be a fixed wing assembly attached to the fuselage 304a. The wing assembly 308a is shown in FIG. 3A as having a first wing segment 309a and a second wing segment 310a. The carrier AV 300a may further include a tail section 312a connected to and extending from the fuselage 304a. The tail section 312a may include one or more tail members or control surface 313a. The tail section 312a may be attached via an internal load bearing frame of the fuselage 304a, which may have a hollow interior channel that carries wires for electrically coupling actuators and rotors and other controls and/or sensors to avionics of the AV 300a. The tail members 313a in some cases may be movable flight control surfaces moved by actuators to facilitate movement and control of the aircraft.

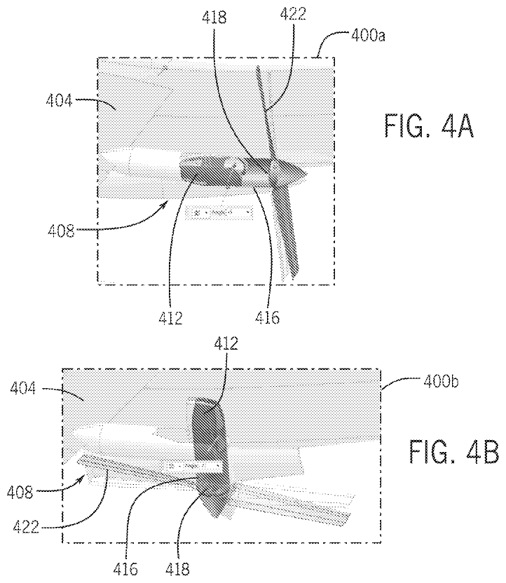

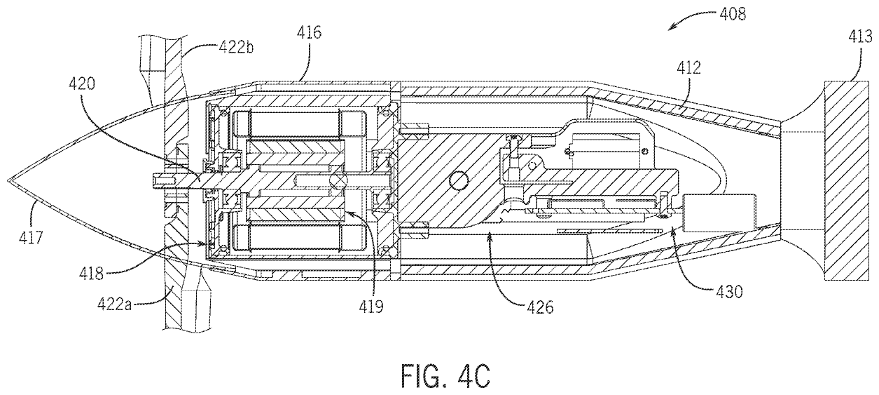

The carrier AV 300a is shown having a propulsion system 316a. The propulsion system 316a may be configured to induce a forward travel of the carrier AV 300a. The propulsion system 316a may be further configured to induce a hover operation of the carrier AV 300a. To facilitate the foregoing, the propulsion system 316a may include a plurality of rotor assemblies, such as a first rotor assembly 320a and a second rotor assembly 324a, as shown in FIG. 3A. In the example of FIG. 3A, the first rotor assembly 320a is shown associated with the wing assembly 308a and the second rotor assembly 324a is shown associated with the tail section 312a. One or both of the first and second rotor assemblies 320a, 324a may be configured to transition between a first configuration optimized for the forward travel of the carrier AV 300a and a second configuration optimized for a hovering operation of the carrier AV 300a. For example, one or both of the first and second rotor assemblies 320a, 324a may include an airfoil 328a that is movable between a first orientation in which an axis of rotation of the airfoil 328a is substantially parallel with a ground surface (to support forward travel) and a second orientation in which the axis of rotation is substantially perpendicular with the ground surface (to support hover). In this regard, FIG. 3B shown an articulation feature 332a which may facilitate the movement of the airfoil 328a between the first and second orientation, such as via a joint or hinge and that movable by an actuator, as one example and as illustrated in greater detail below with respect to FIGS. 4A-4C.

The carrier AV 300a may also include a release assembly 336a. The release assembly 336a may generally operate to hold the second or ancillary AV within the carrier AV 300a. The release assembly 336a may be configured to cause a release of the ancillary AV from the carrier AV 300a at a payload drop location or other location. As one example, the release assembly 336a may include a pair of articulable doors 340a that are moveable between a closed and open configuration. In the closed configuration shown in FIG. 3A, the articulable doors 340a may restrain the ancillary AV from exiting the carrier AV 300a. When the articulable doors 340a are moved to the open configuration, the ancillary AV may be permitted to descend to designated payload drop location for release and delivery of the payload. The ancillary AV may be retracted or recalled to the carrier AV 300a after delivery, such as via a retraction mechanism. The articulable doors 340a may subsequently return to the closed configuration shown in FIG. 3A in order to secure the ancillary AV within the carrier AV 300a for travel back to the payload receiving location or other location.

FIGS. 3C and 3D depict another example carrier autonomous vehicle (AV) 300c. The carrier AV 300c may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300c may be configured to hold an ancillary AV, including a payload, and travel between a payload receiving location and a payload drop location. The carrier AV 300c may be further configured to release the ancillary AV and payload at the payload drop location for delivery of the payload at a designated drop target. Accordingly and as shown in FIGS. 3C and 3D, the carrier AV 300c may include: a fuselage 304c, a wing assembly 308c, a first wing segment 309c, a second wing segment 310c, a tail section 312c, a tail members 313c, a propulsion system 316c, a first rotor assembly 320c, a second rotor assembly 324c, an airfoil 328c, an articulation feature 332c, a release assembly 336c, and a door 340c, redundant explanation of which is omitted here for clarity.

In the example of FIGS. 3C and 3D, the carrier AV 300c is shown having the second rotor assembly 324 associated with a forward most portion of the fuselage 340c. The articulation feature 332c may move the second rotor assembly 324a between a first orientation to induce a forward flight of the AV 300c, as shown in FIG. 3C, and a second orientation to induce the hovering operation. For example, the articulation feature 332a may cause the second rotor assembly to move the airfoil 328c such that an axis of rotation of the airfoil is substantially perpendicular to a ground surface. The example of FIGS. 3A and 3D also shown the articulable doors 340c in the open configuration, with a second or ancillary AV 342a being release from the carrier AV 300c.

FIG. 3E depicts another example carrier autonomous vehicle (AV) 300e. The carrier AV 300e may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300e may be configured to hold an ancillary AV, including a payload, and travel between a payload receiving location and a payload drop location. The carrier AV 300e may be further configured to release the ancillary AV and payload at the payload drop location for delivery of the payload at a designated drop target. Accordingly and as shown in FIG. 3E, the carrier AV 300e may include: a fuselage 304e, a wing assembly 308e, a first wing segment 309e, a second wing segment 310e, a tail section 312e, a tail members 313e, a propulsion system 316e, a first rotor assembly 320e, a second rotor assembly 324e, an articulation feature 332e, a release assembly 336e, and a door 340e, redundant explanation of which is omitted here for clarity.

In the example of FIG. 3E, the carrier AV 300e is shown having two second rotor assembly 324e. A first of the second rotor assemblies 324e is shown in FIG. 3E as associated with a forward most portion of the fuselage 304e. A second of the second rotor assemblies 324e is shown in FIG. 3E as associated with the tail section 312e. Each of the second rotor assemblies may be configured to transition between the first and second orientations using respective ones of the articulation features 332e.

FIGS. 3F and 3G depict another example carrier autonomous vehicle (AV) 300f. The carrier AV 300f may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300f may be configured to hold an ancillary AV, including a payload, and travel between a payload receiving location and a payload drop location. The carrier AV 300f may be further configured to release the ancillary AV and payload at the payload drop location for delivery of the payload at a designated drop target. Accordingly and as shown in FIGS. 3F and 3G, the carrier AV 300f may include: a fuselage 304f, a wing assembly 308f, a first wing segment 309f, a second wing segment 310f, a tail section 312f, a tail members 313f, a propulsion system 316f, a first rotor assembly 320f, a second rotor assembly 324f, an airfoil 328f, and an articulation feature 332f, redundant explanation of which is omitted here for clarity.

In the example of FIGS. 3F and 3G, the carrier AV 300f is shown having the first rotor assemblies 320 secured to an undersigned of the wing assembly 308f. As further shown in FIG. 300f, the tail members 313f may include two tail members that extend separately from the fuselage 304f. As shown in FIG. 3G, the articulation feature 332f may include a pivot axis of a joint associated with the fuselage 304f. The second rotor assembly 324f may rotate about the articulation feature 332f.

FIGS. 3H and 3I depict another example carrier autonomous vehicle (AV) 300h. The carrier AV 300h may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300h may be configured to hold an ancillary AV, including a payload, and travel between a payload receiving location and a payload drop location. The carrier AV 300h may be further configured to release the ancillary AV and payload at the payload drop location for delivery of the payload at a designated drop target. Accordingly and as shown in FIGS. 3H and 3I, the carrier AV 300h may include: a fuselage 304h, a wing assembly 308h, a first wing segment 309h, a second wing segment 310h, a tail section 312h, a tail members 313h, a propulsion system 316h, a first rotor assembly 320h, a second rotor assembly 324h, an articulation feature 332h, a release assembly 336h, and a door 340h, redundant explanation of which is omitted here for clarity.

In the example of FIGS. 3H and 3I, the carrier AV 300h is shown having lights 344h. The lights 344a may be arranged on each of the first wing segment 309h and the second wing segment 309h, such as at an end most portion of each of the wing segments. In some cases, the lights 344a may be associated with or include avionics-based sensors and/or indicators. With respect to FIG. 3I, a profile view of the fuselage 304h is shown, with a wing assembly attachment portion 311h and the articulable door 340h conforming or matching the profile of the fuselage 304a.

FIGS. 3J and 3K depict another example carrier autonomous vehicle (AV) 300j. The carrier AV 300j may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300j may be configured to hold an ancillary AV, including a payload, and travel between a payload receiving location and a payload drop location. The carrier AV 300j may be further configured to release the ancillary AV and payload at the payload drop location for delivery of the payload at a designated drop target. Accordingly and as shown in FIGS. 3J and 3K, the carrier AV 300j may include: a fuselage 304j, a wing assembly 308j, a first wing segment 309j, a second wing segment 310j, a tail section 312j, a tail members 313j, a propulsion system 316j, a first rotor assembly 320j, a second rotor assembly 324j, an airfoil 328j, an articulation feature 332j, and a release assembly 336j, redundant explanation of which is omitted here for clarity.

In the example of FIGS. 3J and 3K, the carrier AV 300j is shown having two second rotor assembly 324j. A first of the second rotor assemblies 324j is shown in FIG. 3J as associated with a forward most portion of the fuselage 304j. A second of the second rotor assemblies 324j is shown in FIG. 3J as associated with the tail section 312j. The second rotor assembly 324j associated with the forward most portion of the fuselage 304j may be configured to transition between the first and second orientations using the articulation feature 332j. The second of the second rotor assemblies 324j may have a generally fixed orientation, such as having an axis of rotation that is generally fixed substantially parallel to a direction of travel of the carrier AV 300j.

FIG. 3L depicts another example carrier autonomous vehicle (AV) 3001. The carrier AV 300l may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300l may be configured to hold an ancillary AV, including a payload, and travel between a payload receiving location and a payload drop location. The carrier AV 300l may be further configured to release the ancillary AV and payload at the payload drop location for delivery of the payload at a designated drop target. Accordingly and as shown in FIG. 3L, the carrier AV 300a may include: a fuselage 304l, a wing assembly 308l, a first wing segment 309l, a second wing segment 310l, a tail section 312l, a tail members 313l, a propulsion system 316l, a first rotor assembly 320l, a second rotor assembly 324l, an airfoil 328l, an articulation feature 332l, and a release assembly 336l, redundant explanation of which is omitted here for clarity.

FIGS. 3M and 3N depict another example carrier autonomous vehicle (AV) 300m. The carrier AV 300m may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300m may be configured to hold an ancillary AV, including a payload, and travel between a payload receiving location and a payload drop location. The carrier AV 300m may be further configured to release the ancillary AV and payload at the payload drop location for delivery of the payload at a designated drop target. Accordingly and as shown in FIGS. 3M and 3N, the carrier AV 300m may include: a fuselage 304m, a wing assembly 308m, a first wing segment 309m, a second wing segment 310m, a tail section 312m, a tail members 313m, a propulsion system 316m, a first rotor assembly 320m, a second rotor assembly 324m, an airfoil 328m, an articulation feature 332m, a release assembly 336m, a door 340m, and an ancillary AV 390m, redundant explanation of which is omitted here for clarity.

FIG. 30 depict another example carrier autonomous vehicle (AV) 300o. The carrier AV 300o may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300o may be configured to hold an ancillary AV, including a payload, and travel between a payload receiving location and a payload drop location. The carrier AV 300o may be further configured to release the ancillary AV and payload at the payload drop location for delivery of the payload at a designated drop target. Accordingly and as shown in FIG. 30, the carrier AV 300o may include: a fuselage 304o, a wing assembly 308o, a first wing segment 309o, a second wing segment 310o, a tail section 312o, a tail members 313o, a propulsion system 316o, a first rotor assembly 320o, a second rotor assembly 324o, an articulation feature 332o, a release assembly 336o, redundant explanation of which is omitted here for clarity.

FIG. 3P depicts another example carrier autonomous vehicle (AV) 300p. The carrier AV 300p may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300p may be configured to hold an ancillary AV, including a payload, and travel between a payload receiving location and a payload drop location. The carrier AV 300p may be further configured to release the ancillary AV and payload at the payload drop location for delivery of the payload at a designated drop target. Accordingly and as shown in FIG. 3P, the carrier AV 300p may include: a fuselage 304p, a wing assembly 308p, a first wing segment 309p, a second wing segment 310p, a tail section 312p, a tail members 313p, a propulsion system 316p, a first rotor assembly 320p, a second rotor assembly 324p, an articulation feature 332p, a release assembly 336p, and sensors 344p, redundant explanation of which is omitted here for clarity.

FIG. 3Q depicts another example carrier autonomous vehicle (AV) 300q. The carrier AV 300q may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300q may be configured to hold an ancillary AV, including a payload, and travel between a payload receiving location and a payload drop location. The carrier AV 300q may be further configured to release the ancillary AV and payload at the payload drop location for delivery of the payload at a designated drop target. Accordingly and as shown in FIG. 3Q, the carrier AV 300q may include: a fuselage 304q, a wing assembly 308q, a first wing segment 309q, a second wing segment 310q, a tail section 312q, a tail members 313q, a propulsion system 316q, a first rotor assembly 320q, a second rotor assembly 324q, an airfoil 328q, an articulation feature 332q, and a release assembly 336q, redundant explanation of which is omitted here for clarity.

FIG. 3R depicts another example carrier autonomous vehicle (AV) 300r. The carrier AV 300r may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300r may be configured to hold an ancillary AV, including a payload, and travel between a payload receiving location and a payload drop location. The carrier AV 300r may be further configured to release the ancillary AV and payload at the payload drop location for delivery of the payload at a designated drop target. Accordingly and as shown in FIG. 3R, the carrier AV 300r may include: a fuselage 304r, a wing assembly 308r, a first wing segment 309r, a second wing segment 310r, a tail section 312r, a tail members 313r, a propulsion system 316r, a first rotor assembly 320r, a second rotor assembly 324r, an airfoil 328r, an articulation feature 332r, and a release assembly 336r, redundant explanation of which is omitted here for clarity.

FIG. 3S depicts another example carrier autonomous vehicle (AV) 300s. The carrier AV 300s may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300s may be configured to hold an ancillary AV, including a payload, and travel between a payload receiving location and a payload drop location. The carrier AV 300s may be further configured to release the ancillary AV and payload at the payload drop location for delivery of the payload at a designated drop target. Accordingly and as shown in FIG. 3S, the carrier AV 300s may include: a fuselage 304s, a wing assembly 308s, a first wing segment 309s, a second wing segment 310s, a tail section 312s, a tail members 313s, a propulsion system 316s, a first rotor assembly 320s, a second rotor assembly 324s, an articulation feature 332s, and a release assembly 336s, redundant explanation of which is omitted here for clarity.

FIG. 3T depicts another example carrier autonomous vehicle (AV) 300t. The carrier AV 300t may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300t may be configured to hold an ancillary AV, including a payload, and travel between a payload receiving location and a payload drop location. The carrier AV 300t may be further configured to release the ancillary AV and payload at the payload drop location for delivery of the payload at a designated drop target. Accordingly and as shown in FIG. 3T, the carrier AV 300t may include: a fuselage 304t, a wing assembly 308t, a first wing segment 309t, a second wing segment 310t, a tail section 312t, a tail members 313t, a propulsion system 316t, a first rotor assembly 320t, a second rotor assembly 324t, an airfoil 328t, an articulation feature 332t, and a release assembly 336t, redundant explanation of which is omitted here for clarity.

FIG. 3U depicts another example carrier autonomous vehicle (AV) 300u. The carrier AV 300u may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300u may be configured to hold an ancillary AV, including a payload, and travel between a payload receiving location and a payload drop location. The carrier AV 300u may be further configured to release the ancillary AV and payload at the payload drop location for delivery of the payload at a designated drop target. Accordingly and as shown in FIG. 3U, the carrier AV 300u may include: a fuselage 304u, a wing assembly 308u, a first wing segment 309u, a second wing segment 310u, a tail section 312u, a tail members 313u, a propulsion system 316u, a first rotor assembly 320u, a second rotor assembly 324u, an airfoil 328u, an articulation feature 332u, and a release assembly 336u, redundant explanation of which is omitted here for clarity.

FIG. 3V depicts another example carrier autonomous vehicle (AV) 300v. The carrier AV 300v may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300v may be configured to hold an ancillary AV, including a payload, and travel between a payload receiving location and a payload drop location. The carrier AV 300v may be further configured to release the ancillary AV and payload at the payload drop location for delivery of the payload at a designated drop target. Accordingly and as shown in FIG. 3V, the carrier AV 300v may include: a fuselage 304v, a wing assembly 308v, a first wing segment 309v, a second wing segment 310v, a tail section 312v, a tail members 313v, a propulsion system 316v, a first rotor assembly 320v, a second rotor assembly 324v, an articulation feature 332v, and a release assembly 336v, redundant explanation of which is omitted here for clarity.

FIG. 3W depicts another example carrier autonomous vehicle (AV) 300w. The carrier AV 300w may be substantially analogous to any of the carrier AVs or first AVs or the like, described herein, such as the carrier AV 204 of FIGS. 2A-2D, carrier AV 300a of FIGS. 3A and 3B, and so on. In this regard, the carrier AV 300w may be configured to hold an ancillary AV, including a payload, and travel between a payload receiving location and a payload drop location. The carrier AV 300w may be further configured to release the ancillary AV and payload at the payload drop location for delivery of the payload at a designated drop target. Accordingly and as shown in FIG. 3W, the carrier AV 300w may include: a fuselage 304w, a wing assembly 308w, a first wing segment 309w, a second wing segment 310w, a tail section 312w, a tail members 313w, a propulsion system 316w, a first rotor assembly 320w, a second rotor assembly 324w, an airfoil 328w, an articulation feature 332w, a release assembly 336w, and a door 340w, redundant explanation of which is omitted here for clarity.

FIGS. 4A-4C depict an example rotor assembly 408. The rotor assembly 408 may be a rotor assembly of any of the carrier autonomous vehicles of FIGS. 3A-3W. The rotor assembly 408 includes a mount structure 408. The mount structure 408 may define a housing or structural component of the rotor assembly 408 that is attached to a portion 404 of an aircraft (e.g., a portion of any of the carrier autonomous vehicles of FIGS. 3A-3W). The rotor assembly 408 further includes a housing component 416. The housing component 416 may be rotatably coupled to the mount structure 412. The housing component 416 may generally be a hollow structure that holds various internal components of the rotor assembly 408, such as a motor component. A rotation assembly 418 may be positioned substantially within the housing component 416 and configured to cause a rotation of an airfoil 422. The rotation assembly 418 may be configured to rotate the airfoil 422 in order to generate a lift force based on the direction of the housing component 416 relative to the mount structure 412.

The rotor assembly 408 may be configured to transition between a first configuration that induces a forward movement of the AV, and a second configuration that induces a hover of the AV. In the example of FIG. 4A, the rotor assembly 408 is shown in a first configuration 400a. In the first configuration, the airfoil 422 is configured to rotate about an axis that is substantially perpendicular with a direction of travel of the carrier AV. The first configuration 400a may be used during a travel of the carrier AV between the payload receiving location and the payload drop location. The carrier AV may subsequently transition to a second configuration 400b, as shown in FIG. 4B. In the second configuration 400b, the airfoil 422 is configured to rotate about an axis that is arrange along a direction that is different from the axis of rotation of the first configuration 400a. For example, in the second configuration 400b, the airfoil 422 may be configured to rotate about an axis that is substantially perpendicular to a ground surface. The second configuration 400b may be used during a hover of the carrier AV at the payload drop location.

With respect to FIG. 4C, an example cross-sectional view of the rotor assembly 408 is shown, including illustrative components and systems to facilitate the foregoing functionality of the configurations 400a, 400b described above. For example, the rotor assembly 408 is shown in FIG. 4C as including the rotation assembly 418. The rotation assembly 418 may include a motor 419 and a shaft 420. The motor 419 may be an electric or inductive motor that is configured to rotate the shaft 420 upon the receipt of an electric current. The shaft 420 may be coupled to the airfoil 422. For example, the shaft 420 may be coupled to a first airfoil portion 422a and a second airfoil portion 422b. The rotation of the shaft 420 by the motor 419 may in turn cause rotation of the first and second airfoil portions 422a, 422b. A nosecone 417 may be seated about the shaft 420 and arranged to block the rotation assembly 418 and other internal component of the rotor assembly from debris.

The rotation assembly 418 may be fixed within the housing component 416. Accordingly, the axis of rotation of the shaft 420 may be fixed relative to the housing component 416. The housing component 416 may be rotatable relative to the mount structure 412. The rotation of the housing component 416 may therefore alter the orientation of the axis of rotation of the shaft 420, such as altering the orientation between the first and second configurations 400a, 400b shown above with respect to FIGS. 4A and 4B. To facilitate the foregoing, the mount structure 412 may include an actuation system 426. The actuation system 428 may include one or more servomotors or other control devices that operate to cause a movement of the housing portion 416 relative to the mount structure 412. A control system 430 may be provided with the mount structure 412 to provide an input signal that prompts the actuation system 428 to move the housing portion 416. In turn, the control system 430 may be electrically coupled to avionics of the AV. An attachment portion 413 is optionally provide to fix the rotor assembly to the portion 404 of the carrier AV, such as to a wing assembly, fuselage, or other portion of the carrier AV.

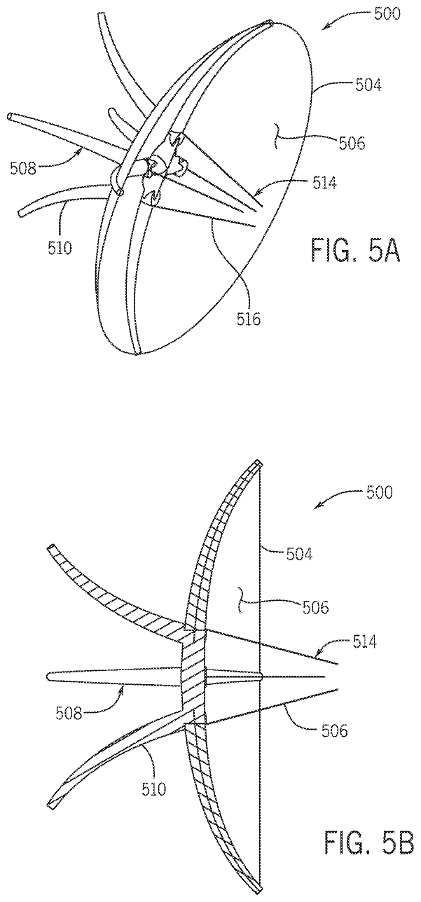

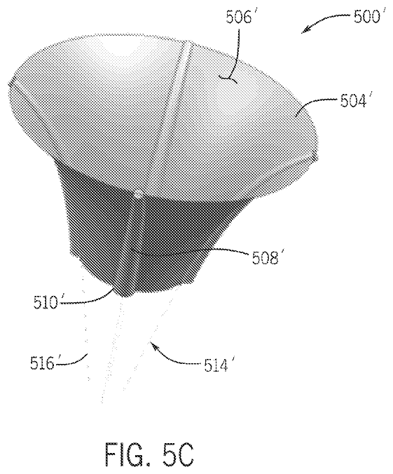

FIGS. 5A-5C depict example recovery mechanisms of any of the carrier autonomous vehicles of FIGS. 3A-3W. The recovery mechanism may be configured to cause a controlled descent of the carrier AV during a hover operation. In the event of an emergency scenario, including but not limited, to a mechanical or electrical failure of the AV, the recovery mechanism can be deployed. The recovery system can be deployed from a hover configuration of the carrier AV or otherwise when the AV has a zero or near-zero forward movement.

With respect to FIGS. 5A and 5B, a recovery mechanism 500 is shown. The recovery mechanism 500 includes a fabric portion 504 and a plurality of deployable member 508. The fabric portion 504 may define a canopy 506 having a substantially parabolic shape. The canopy 506 may be configured to increase air resistance in order to reduce a rate of descent of the carrier AV. The fabric portion 504 may be supported by the plurality of deployable members 508. The plurality of deployable members 508 may include a collection of inflatable tubes 510. The plurality of deployable members 508 may be configured to expand upon release from the carrier AV. In some cases, a pyrotechnic device or effect may be used to expand the deployable members 508 by inflating one or more of the inflatable tubes 510. Upon inflation, the recovery mechanism 500 may remain attached to the carrier AV using an attachment feature 514 having cords 516.

In operation, the recovery mechanism 500 is configured to allow the inflatable tubes 510 to collapse if the recovery mechanism 500 is deployed at high speed. This can limit arresting forces on the inflatable tubes 510 and allow the fabric portion 504 to act as a parachute at high speeds, thereby reducing a shock load on the associated AV. At lower speeds, the inflatable tubes 510 are configured to restore the parabolic shape of the canopy 506 in order to reduce a descent rate. Accordingly, the recovery mechanism 500 is adaptable to the speed of the AV to provide a controlled descent in a variety of operational scenarios.

With reference to FIG. 5C another example recovery mechanism 500′ is illustrated. The recovery mechanism 500′ may be substantially analogous to the recovery mechanism 500 and include: a fabric portion 504′, a canopy 506′, a plurality of deployable members 508′, inflatable tubes 510′, an attachment feature 514′, and cords 516′, redundant explanation of which is omitted herein for clarity.

FIGS. 6A-6E depict example implementations of the second or ancillary autonomous vehicle 212 of the system 100. For example, FIG. 6A depicts an example ancillary autonomous vehicle (AV) 600a. The ancillary AV 600a may be substantially analogous to any of the ancillary AVs or second AVs or the like, described herein, such as the ancillary AV 212 of FIGS. 2A-2D. In this regard, the ancillary AV 600a may be coupled to a carrier AV, such as being held substantially within the carrier AV for travel to the payload drop location. The ancillary AV 600a may be further configured to travel between the carrier AV and a designated drop target adjacent to a ground or receiving surface at the payload drop location. The ancillary AV 600a may also be coupled with a payload or package. The AV 600a may be further configured to release the payload or package at a designated drop target adjacent to a ground or receiving surface at the payload drop location.

In the example of FIG. 6A, the ancillary AV 600a may include a body 604. The body 604a may be a structural portion of the AV 600a that is configured to hold or otherwise be coupled with the payload. The body 604a may be connected to a payload release assembly 608a. The payload release assembly 608a may generally include an articulable feature, such as doors, hooks, latches, and so on that are configured to transition between a first secure configuration and a second release configuration. In a first secure configuration, the payload release assembly 608a may restrain a payload and generally prevent the payload from disassociation from the body 604a. In a second release configuration, the payload release assembly 608b may allow for the disassociation of the payload from the body 604. For example, one or more of the doors, hooks, latches, and so on may be disengaged from the payload, allowing the payload to separate from the body 604a as the AV 600a is retracted toward the carrier AV.

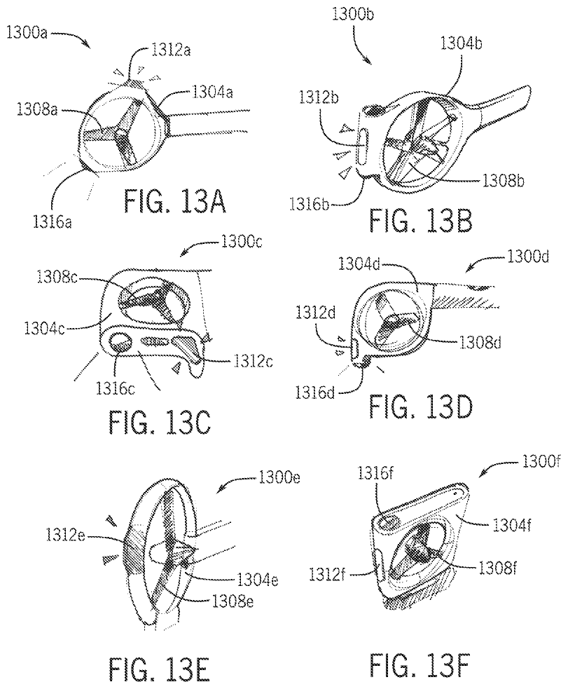

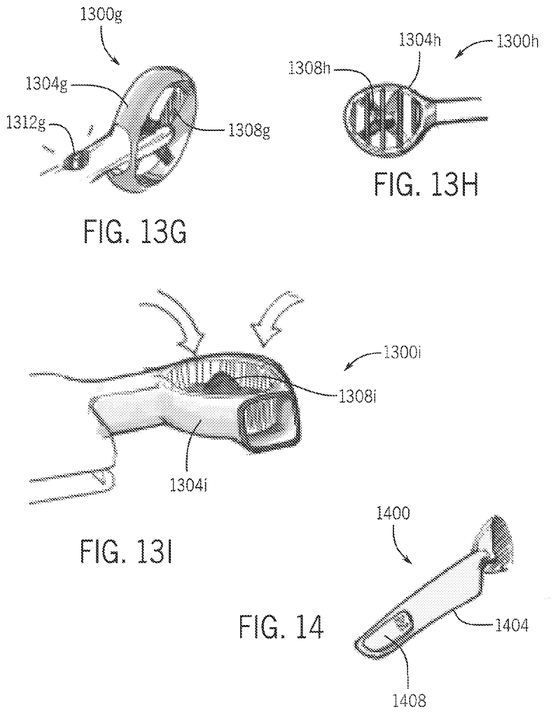

The AV 600a may also include a tether attachment assembly 612a. The tether attachment assembly 616a may be used to couple a tether 616a to the body 604a. As described above, the tether 616a may be used to control a position or distance of travel of the ancillary AV 600a relative to a carrier AV. The tether attachment assembly 612a may secure the tether 616a to the body 604a. The tether attachment assembly 612a may also be configured to release the tether from the body 604a, such as during maintenance or other operations. Example tether attachment assemblies are presented below in greater detail with respect to FIGS. 13A-13I.

The ancillary AV 600a may include one or more systems or assemblies that are configured to control an orientation or position of the ancillary AV 600a during the travel of ancillary AV 600A between the carrier AV and the designated drop target. For example, the ancillary AV 600a may include one or more components or systems that mitigate spinning of the ancillary AV 600a during descent. Additionally or alternatively, the ancillary AV 600a may include one or more components or systems that influence a position or direction of the ancillary AV 600a, including in some cases controlling a rate of travel of the AV 600a.

To facilitate the foregoing, in the example of FIG. 6A, the ancillary AV 600a includes a control feature 624a and control feature 628a. The control feature 624a may include a fan or a component configured to move air. For example, the control feature 624a may include an airfoil or rotor that rotates, and thereby produces a lift force relative to the body 604a. The control feature 624a may be connected to the body 604a by a support section 620a. The support section 620a may define a housing and/or structural component for the fan or other control feature 624a. In some cases, the support section 620a may include a ducting that helps direct a flow of air toward the fan of the control feature 624a. The control feature 628a may be an internal component of the body 604a that rotates in order to balance or mitigate angular momentum of the AV 600a. For example, the control feature 628a may be an internal feature, such as an inertia wheel, that spins a predetermined or control rate within the body 604a. The inertia wheel may have a known mass distribution that induces a known angular momentum with the body 604a upon rotation of the wheel. This induced angular momentum can be tuned to counteract the angular momentum of the body 604a that may result as the AV 600a travels from the carrier AV. In some cases, the induced angular momentum can be tuned to counteract the angular momentum of the body 604a in a manner that substantially prevents spinning or other rotational movement of the AV 600a during descent. Additionally, the inertia wheel of the orientation component 628a may be configured to cooperate with the orientation component 624a to further control the orientation of the AV 600a and reduce spinning. As one example, each of the orientation components 624, 628 may be configured to induce an angular component about deferent axes in order to counteract the impact of angular component in multiple directions, further stabilizing the AV 600a.

FIGS. 6B and 6C depict another example ancillary autonomous vehicle (AV) 600b. The ancillary AV 600b may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 600b may be coupled with a first or carrier AV and coupled with a payload or package. The ancillary AV 600b may be further configured to travel between the first or carrier AV and a designated drop target adjacent to a ground or receiving surface at a payload drop location and release the payload at the drop target. Accordingly and as shown in FIGS. 6B and 6C, the ancillary AV 600c may include: a body 604b, a payload release assembly 608b, a tether attachment assembly 612b, a tether 616b, support section 620b, and a control feature 624b, redundant explanation of which is omitted here for clarity.

In the example of FIG. 6B, the control feature 624b of the ancillary AV 300b is shown as being moveable using an articulation feature 622b. The control feature 624b may be a fan or air duct that is engaged with the support section 620b. The articulation feature 622b may include at least one track defined with the support section 620b that receive a portion of the control feature 640b. The articulation feature 622b may cause the control feature 624b to transition between a first configuration shown in FIG. 6B and a second configuration shown in FIG. 6C.

FIG. 6D depicts another example ancillary autonomous vehicle (AV) 600d. The ancillary AV 600d may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 600d may be coupled with a first or carrier AV and coupled with a payload or package. The ancillary AV 600d may be further configured to travel between the first or carrier AV and a designated drop target adjacent to a ground or receiving surface at a payload drop location and release the payload at the drop target. Accordingly and as shown in FIG. 6D, the ancillary AV 600d may include: a body 604d, a payload release assembly 608d, a tether attachment assembly 612d, a tether 616d, support section 620d, an articulation feature 622d, and a control feature 624d, redundant explanation of which is omitted here for clarity. The articulation feature 622d may cause a movement of the control feature 624d relative to the body 604d.

FIG. 6E depict another example ancillary autonomous vehicle (AV) 600e. The ancillary AV 600e may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 600e may be coupled with a first or carrier AV and coupled with a payload or package. The ancillary AV 600e may be further configured to travel between the first or carrier AV and a designated drop target adjacent to a ground or receiving surface at a payload drop location and release the payload at the drop target. Accordingly and as shown in FIG. 6E, the ancillary AV 600e may include: a body 604e, a payload release assembly 608e, a tether attachment assembly 612e, a tether 616e, support section 620e, an articulation feature 622e, and a control feature 624e, redundant explanation of which is omitted here for clarity. The articulation feature 622e may cause a movement of the control feature 624e relative to the body 604e.

FIG. 6F depicts another example ancillary autonomous vehicle (AV) 600f. The ancillary AV 600f may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 600f may be coupled with a first or carrier AV and coupled with a payload or package. The ancillary AV 600f may be further configured to travel between the first or carrier AV and a designated drop target adjacent to a ground or receiving surface at a payload drop location and release the payload at the drop target. Accordingly and as shown in FIG. 6F, the ancillary AV 600f may include: a body 604f, a payload release assembly 608f, a tether attachment assembly 612f, a tether 616f, support section 620f, an articulation feature 622f, a control feature 624f, and a control feature 628f, redundant explanation of which is omitted here for clarity. The articulation feature 622f may cause a movement of the control feature 624f relative to the body 604f.

FIGS. 7A-9D depicts example implementations of second or ancillary autonomous vehicle 212 of the system 100. With reference to FIGS. 7A-7D, examples are shown as having a pilled shaped base, no sharp angles, and ducted fans arranged in a lateral configuration. For example, in FIG. 7A an ancillary AV 700a is shown as having a container portion 708a with ducted fans 704a arranged in a lateral configuration. As a further example, in FIGS. 7B and 7C, an ancillary AV 700a is shown as having a payload portion 708b coupled to a base 712b, which may be pilled shaped and having no sharp angles. The base 712b is connected with ducted fans 704b in a lateral configuration on opposing ends of the base 712b.

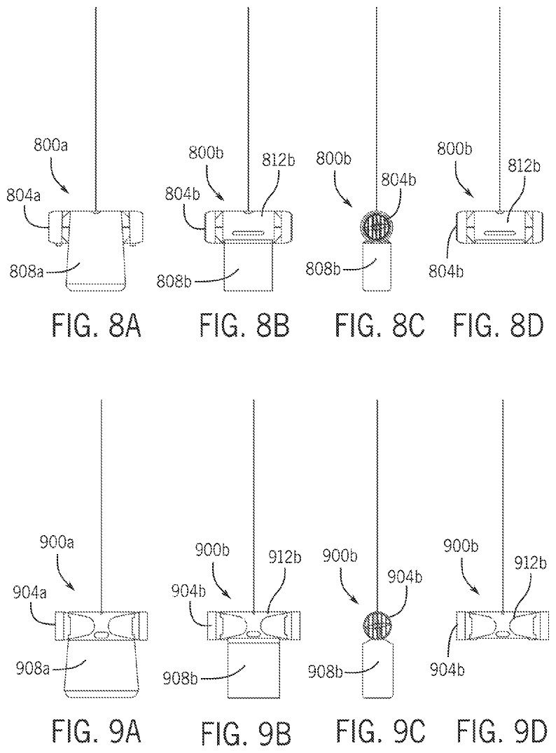

With reference to FIGS. 8A-8D, examples are shown as having a truncated pill shaped base and ducted fans arranged in a lengthwise configuration. For example, in FIG. 8A an ancillary AV 800a is shown as having a container portion 808a with ducted fans 804a arranged in a lengthwise configuration. As a further example, in FIGS. 8B and 8C, an ancillary AV 800a is shown as having a payload portion 808b coupled to a base 812b, which may be a truncated pilled shaped and having no sharp angles. The base 812b is connected with ducted fans 804b in a lengthwise configuration on opposing ends of the base 812b.

With reference to FIGS. 9A-9D, examples are shown as having a truncated cylinder base and ducted fans arranged in a lengthwise configuration. For example, in FIG. 9A an ancillary AV 900a is shown as having a container portion 908a with ducted fans 904a arranged in a lengthwise configuration. As a further example, in FIGS. 9B and 9C, an ancillary AV 900a is shown as having a payload portion 908b coupled to a base 912b, which may be truncated cylinder shaped. The base 912b is connected with ducted fans 904b in a lateral configuration on opposing ends of the base 912b.

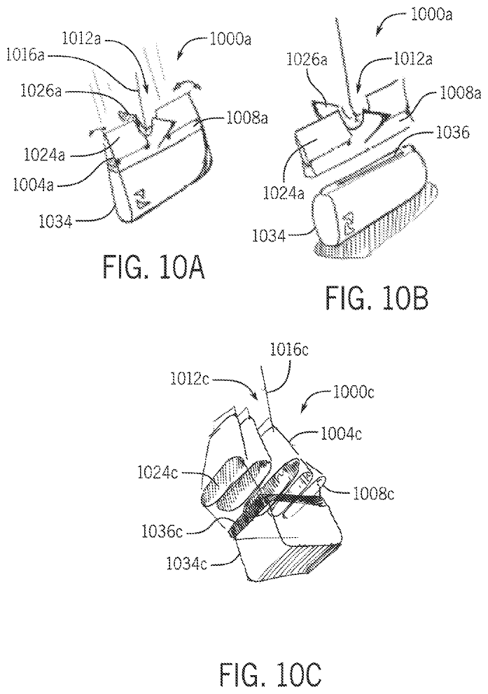

FIGS. 10A-10C depicts example implementations of second or ancillary autonomous vehicle (AV) 212 of the system 100. In the example of FIGS. 10A-10C, the ancillary AVs are shown as having control features that are defined by substantially passive aerodynamic surfaces, such as fins, wings, tails, canopies, or other surface that are configured to control an orientation or position of the ancillary AV as the ancillary AV travels from the carrier AV and to the designated drop target.

With reference to FIGS. 10A and 10B, an example ancillary autonomous vehicle (AV) 1000a is depicted. The ancillary AV 1000a may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 1000a may be coupled with a first or carrier AV and coupled with a payload or package. The ancillary AV 1000a may be further configured to travel between the first or carrier AV and a designated drop target adjacent to a ground or receiving surface at a payload drop location and release the payload at the drop target. Accordingly and as shown in FIGS. 10A and 10B, the ancillary AV 1000a may include: a body 1004a, a payload release assembly 1008a, a tether attachment assembly 1012a, a tether 1016a, a control feature 1024a, and a control feature 1026a, redundant explanation of which is omitted here for clarity.

In the example of FIGS. 10A and 10B, the control features 1024a, 1028b may include passive aerodynamic surfaces. For example, the control feature 1024a may be a pair of wings extending generally along a lengthwise direction of the body 1004a. The control feature 1026b may be a pair of wings extending generally along a width direction of the body 104a, substantially perpendicular to the wings of the control feature 1024a. In the example shown in FIGS. 10A and 10B, the tether 1016a may bisect the wings such that the wings are positioned circumferential spaced about the tether 1016a. In some cases, the wings may be articulable by an actuator or other feature of the AV 1000a. With respect to FIG. 10B, a payload 1034 is show as being released from the AV 1000a. A payload coupling portion 1036a may engage the payload release assembly 1008b. Upon reaching the designated drop target, the payload release assembly 1008b may cause the payload coupling portion 1026a to separate from the AV 1000a, leaving the payload 1034 for subsequent retrieval by the customer.

With reference to FIG. 10C, another example ancillary autonomous vehicle (AV) 1000c is depicted. The ancillary AV 1000c may be substantially analogous to any of the ancillary AVs or second AVs or the like, described herein, such as the ancillary AV 212 of FIGS. 2A-2D, ancillary AV 600a of FIG. 6A, the ancillary AV 1000a of FIGS. 10A and 10B, and so on. In this regard, the ancillary AV 1000c may be coupled with a first or carrier AV and coupled with a payload or package. The ancillary AV 1000c may be further configured to travel between the first or carrier AV and a designated drop target adjacent to a ground or receiving surface at a payload drop location and release the payload at the drop target. Accordingly and as shown in FIG. 10C, the ancillary AV 1000c may include: a body 1004c, a payload release assembly 1008c, a tether attachment assembly 1012c, a tether 1016c, a control feature 1024c, a payload 1034c, and a payload coupling portion 1036c, redundant explanation of which is omitted here for clarity. In the example of FIGS. 10C, the control feature 1024c may function as a parachute or other canopy in order to reduce a rate of travel of the payload 1034c as the payload 1034c descends to the ground.

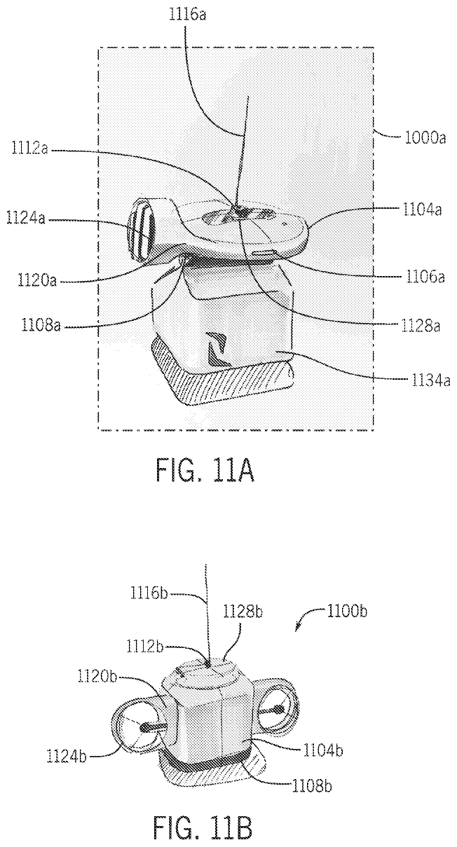

FIGS. 11A-11B depict example implementations of second or ancillary autonomous vehicles 212 of the system 100. In the example of FIGS. 11A and 10B, the ancillary autonomous vehicles are shown as having control features that include an internal inertia wheel. For example and with respect to FIG. 11A another example ancillary autonomous vehicle (AV) 1100a is depicted. The ancillary AV 1100a may be substantially analogous to any of the ancillary AVs or second AVs or the like, described herein, such as the ancillary AV 212 of FIGS. 2A-2D, ancillary AV 600a of FIG. 6A, and so on. In this regard, the ancillary AV 1100a may be coupled with a first or carrier AV and coupled with a payload or package. The ancillary AV 1100a may be further configured to travel between the first or carrier AV and a designated drop target adjacent to a ground or receiving surface at a payload drop location and release the payload at the drop target. Accordingly and as shown in FIG. 11A, the ancillary AV 1100a may include: a body 1104a, sensors 1106a, a payload release assembly 1108a, a tether attachment assembly 1112a, a tether 1116a, support section 1120a, a control feature 624d, a control feature 1128a, and a payload 1134a, redundant explanation of which is omitted here for clarity.

FIG. 11B depicts another example ancillary autonomous vehicle (AV) 1100b. The ancillary AV 1100b may be substantially analogous to any of the ancillary AVs or second AVs or the like, described herein, such as the ancillary AV 212 of FIGS. 2A-2D, ancillary AV 600a of FIG. 6A, ancillary AV 110a of FIG. 11A, and so on. In this regard, the ancillary AV 1100b may be coupled with a first or carrier AV and coupled with a payload or package. The ancillary AV 1100b may be further configured to travel between the first or carrier AV and a designated drop target adjacent to a ground or receiving surface at a payload drop location and release the payload at the drop target. Accordingly and as shown in FIG. 11B, the ancillary AV 1100b may include: a body 1104b, a payload release assembly 1108b, a tether attachment assembly 1112b, a tether 1116b, support section 1120b, a control feature 1124b, and a control feature 1128b, redundant explanation of which is omitted here for clarity.

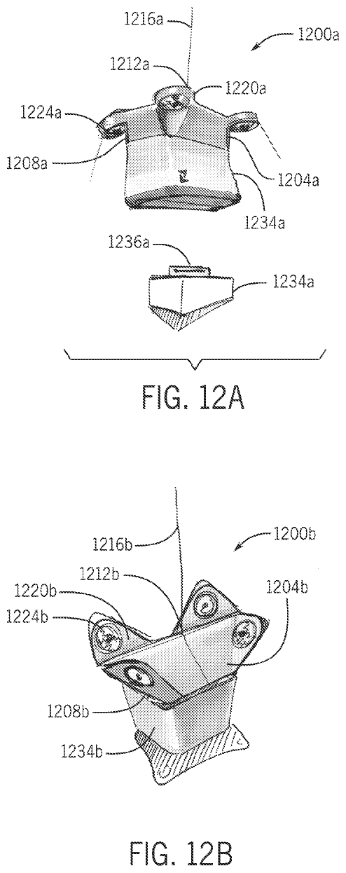

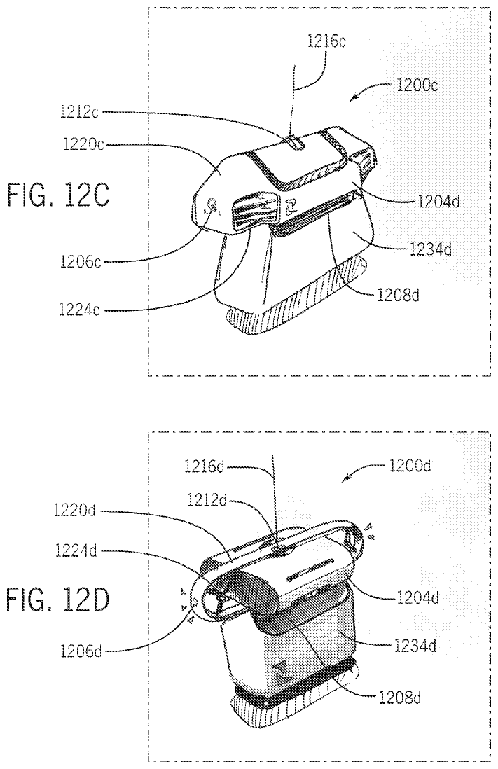

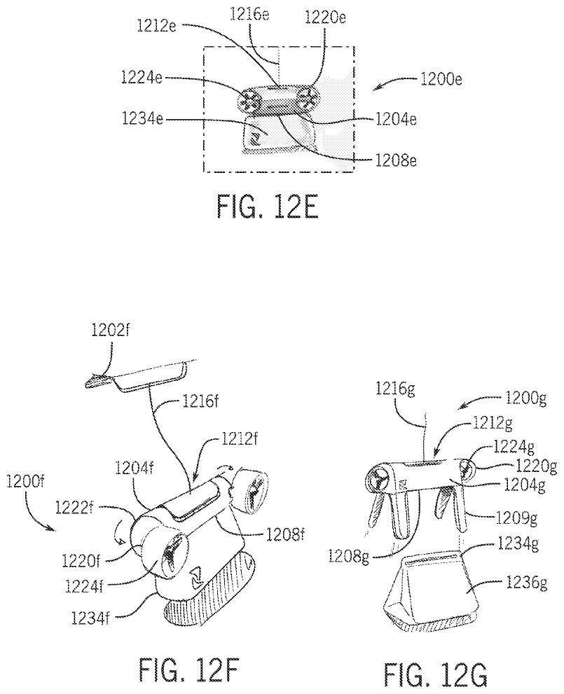

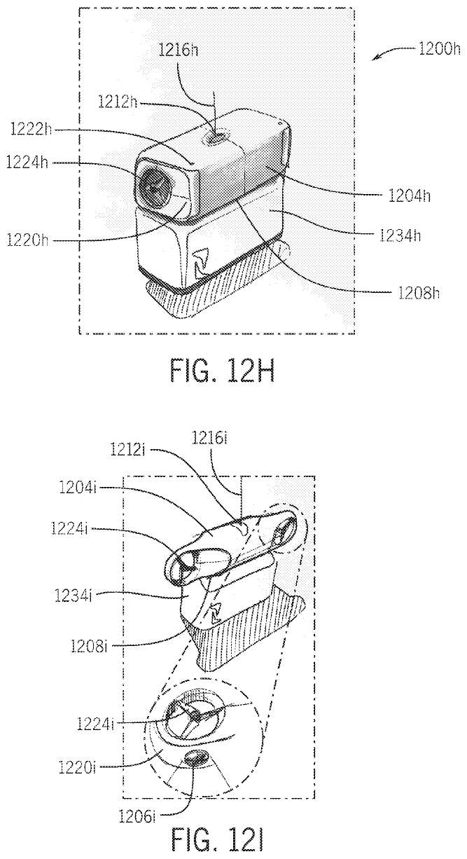

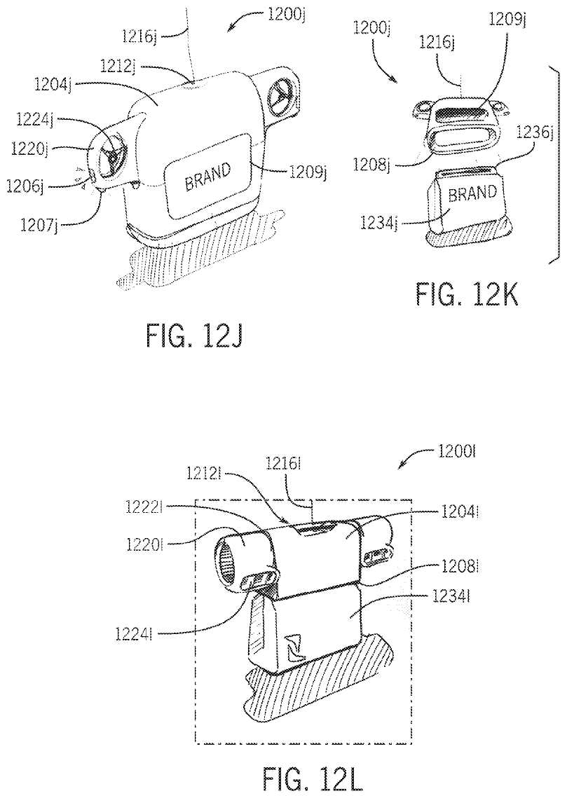

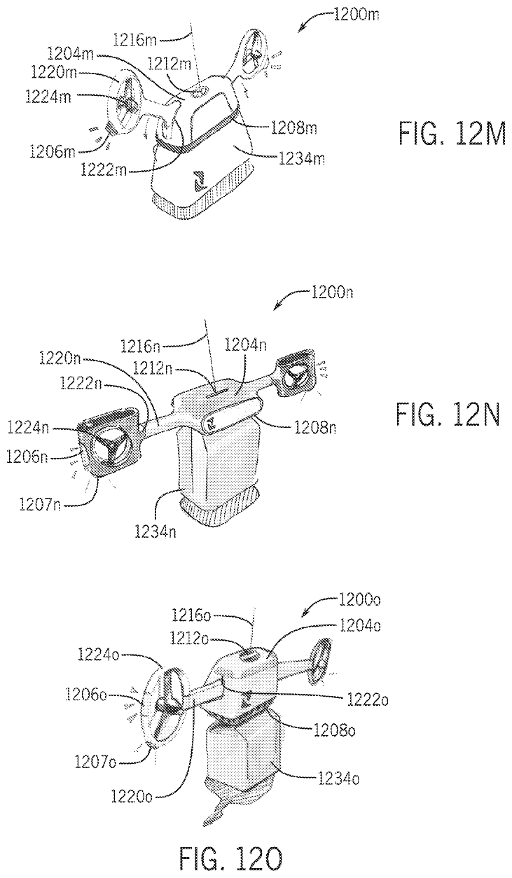

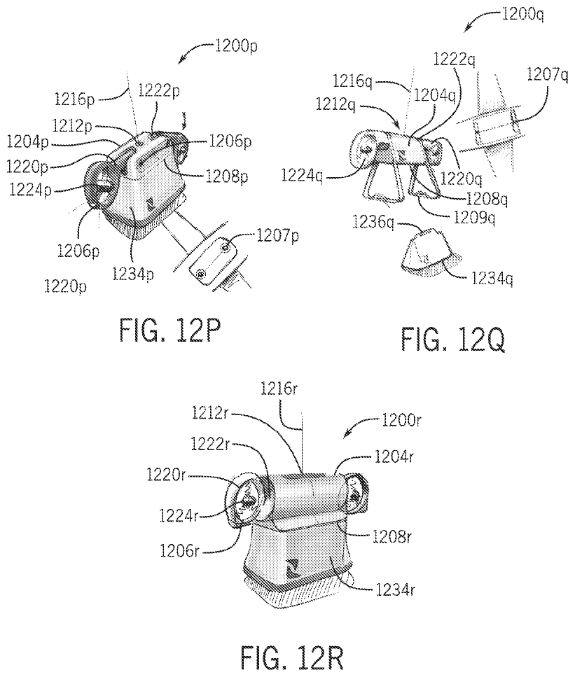

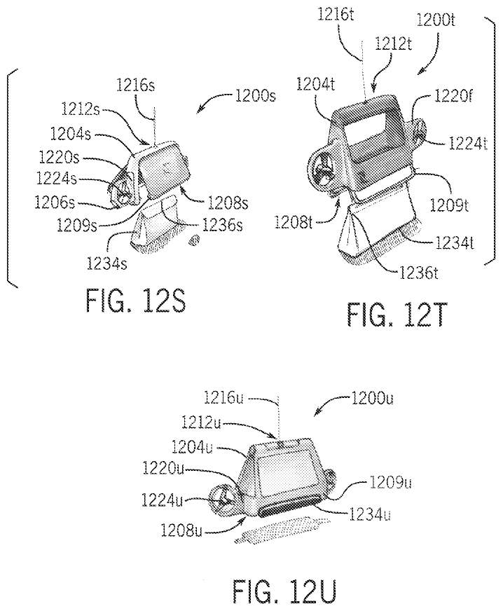

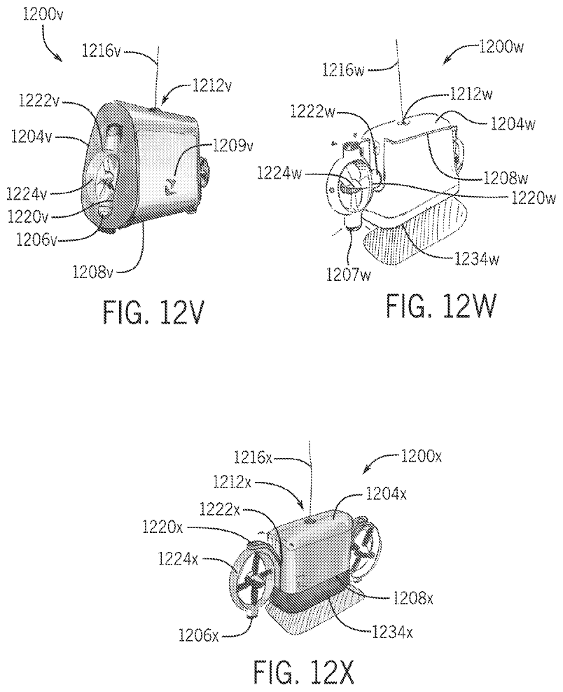

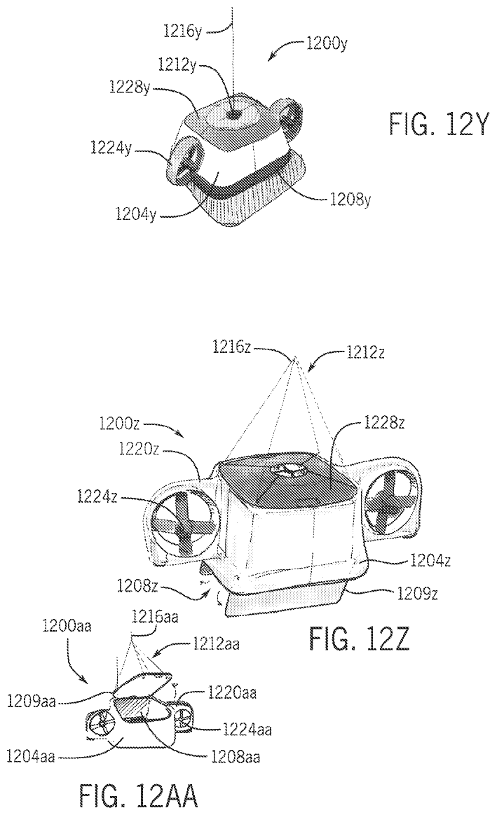

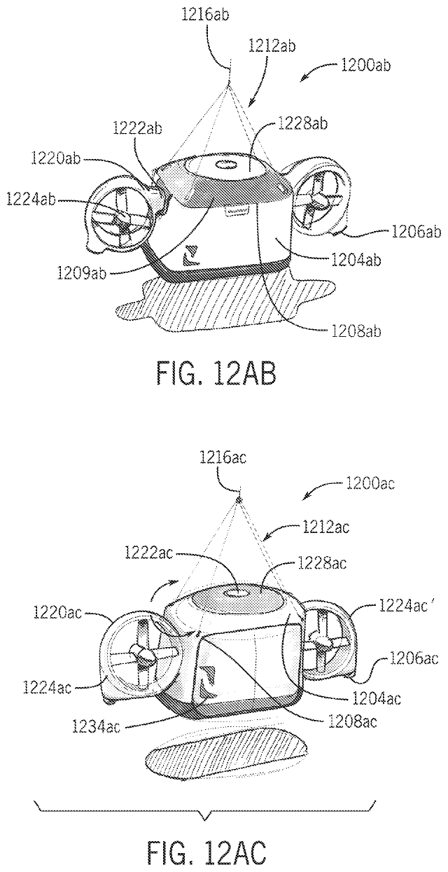

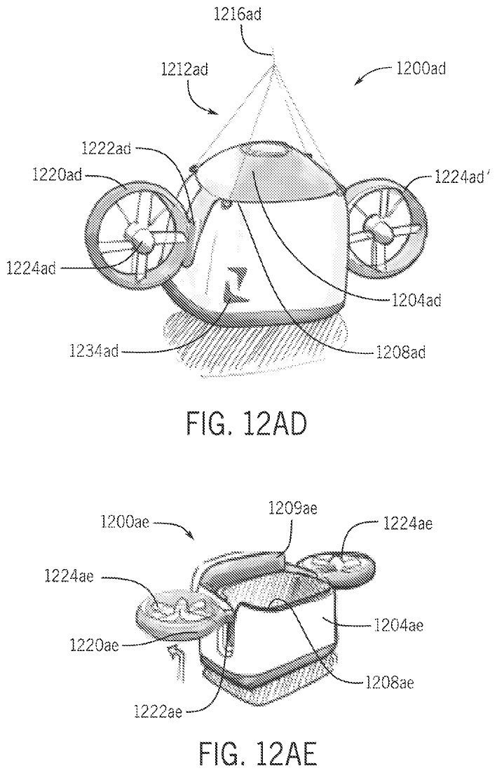

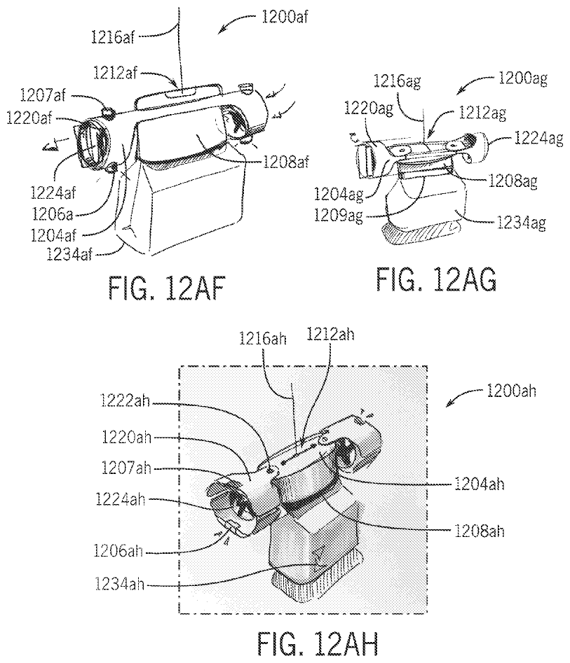

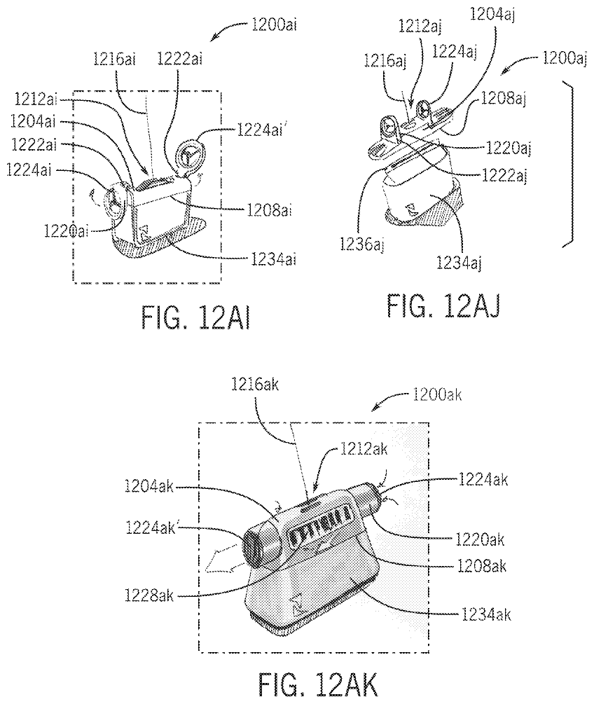

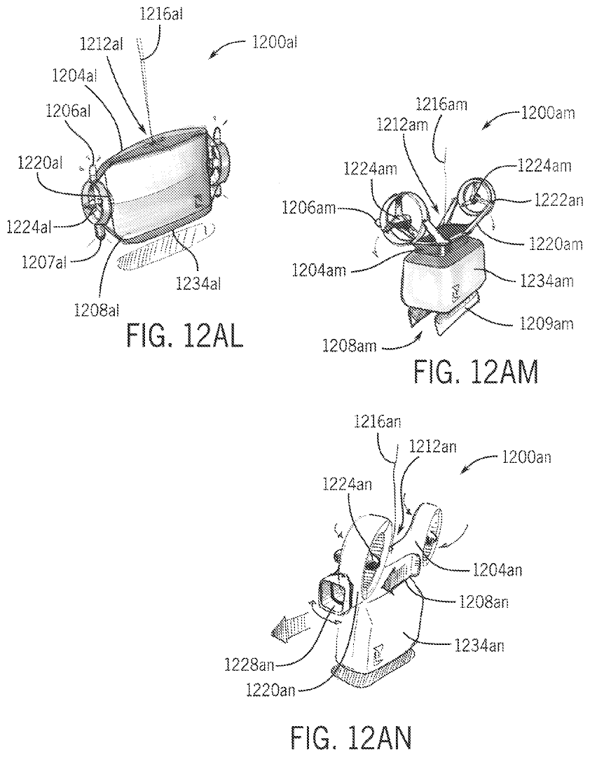

FIGS. 12A-12AN depict example implementations of second or ancillary autonomous vehicle of the system 100. In the example of FIG. 12A, an example ancillary autonomous vehicle (AV) 1200a is depicted. The ancillary AV 1200a may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200a may be coupled with a first or carrier AV and coupled with a payload or package. The ancillary AV 1200a may be further configured to travel between the first or carrier AV and a designated drop target adjacent to a ground or receiving surface at a payload drop location and release the payload at the drop target. Accordingly and as shown in FIG. 12A, the ancillary AV 1200a may include: a body 1204a, a payload release assembly 1208a, a tether attachment assembly 1212a, a tether 1216a, a support section 1220a, a control feature 1224a, a payload 1234a, and a payload coupling portion 1236a, redundant explanation of which is omitted here for clarity.

FIG. 12B depicts another example ancillary autonomous vehicle (AV) 1200b. The ancillary AV 1200b may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200b may be coupled with a first or carrier AV and coupled with a payload or package. The ancillary AV 1200b may be further configured to travel between the first or carrier AV and a designated drop target adjacent to a ground or receiving surface at a payload drop location and release the payload at the drop target. Accordingly and as shown in FIG. 12B, the ancillary AV 1200b may include: a body 1204b, a payload release assembly 1208b, a tether attachment assembly 1212b, a tether 1216b, a support section 1220b, a control feature 1224b, and a payload 1234b, redundant explanation of which is omitted here for clarity.

FIG. 12C depicts another example ancillary autonomous vehicle (AV) 1200c. The ancillary AV 1200c may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200a may be coupled with a first or carrier AV and coupled with a payload or package. The ancillary AV 1200a may be further configured to travel between the first or carrier AV and a designated drop target adjacent to a ground or receiving surface at a payload drop location and release the payload at the drop target. Accordingly and as shown in FIG. 12C, the ancillary AV 1200c may include: a body 1204c, lights 1206c, payload release assembly 1208c, a tether attachment assembly 1212c, a tether 1216c, a support section 1220c, a control feature 1224c, and a payload 1234c, redundant explanation of which is omitted here for clarity.

FIG. 12D depicts another example ancillary autonomous vehicle (AV) 1200d. The ancillary AV 1200d may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200d may be coupled with a first or carrier AV and coupled with a payload or package. The ancillary AV 1200d may be further configured to travel between the first or carrier AV and a designated drop target adjacent to a ground or receiving surface at a payload drop location and release the payload at the drop target. Accordingly and as shown in FIG. 12D, the ancillary AV 1200d may include: a body 1204d, lights 1206d, a payload release assembly 1208d, a tether attachment assembly 1212d, a tether 1216d, a support section 1220d, a control feature 1224d, and a payload 1234d, redundant explanation of which is omitted here for clarity.

FIG. 12E depicts another example ancillary autonomous vehicle (AV) 1200e. The ancillary AV 1200e may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200e may be coupled with a first or carrier AV and coupled with a payload or package. The ancillary AV 1200e may be further configured to travel between the first or carrier AV and a designated drop target adjacent to a ground or receiving surface at a payload drop location and release the payload at the drop target. Accordingly and as shown in FIG. 12E, the ancillary AV 1200e may include: a body 1204e, a payload release assembly 1208e, a tether attachment assembly 1212e, a tether 1216e, a support section 1220e, a control feature 1224e, and a payload 1234e, redundant explanation of which is omitted here for clarity.

FIG. 12F depicts another example ancillary autonomous vehicle (AV) 1200f. The ancillary AV 1200f may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200f may be coupled with a first or carrier AV and coupled with a payload or package. The ancillary AV 1200f may be further configured to travel between the first or carrier AV and a designated drop target adjacent to a ground or receiving surface at a payload drop location and release the payload at the drop target. Accordingly and as shown in FIG. 12F, the ancillary AV 1200f may include: a body 1204f, a payload release assembly 1208f, a tether attachment assembly 1212f, a tether 1216f, a support section 1220f, an articulation feature 1222f, a control feature 1224f, and a payload 1234f, redundant explanation of which is omitted here for clarity. FIG. 12F also shows the tether 1216 connected to and extending from a first or carrier AV 1202f.

FIG. 12G depicts another example ancillary autonomous vehicle (AV) 1200g. The ancillary AV 1200g may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200g may be coupled with a first or carrier AV and coupled with a payload or package. The ancillary AV 1200g may be further configured to travel between the first or carrier AV and a designated drop target adjacent to a ground or receiving surface at a payload drop location and release the payload at the drop target. Accordingly and as shown in FIG. 12G, the ancillary AV 1200g may include: a body 1204g, a payload release assembly 1208g, an articulable release feature 1209g, a tether attachment assembly 1212g, a tether 1216g, a support section 1220g, a control feature 1224g, a payload 1234g, and a payload coupling portion 1236g, redundant explanation of which is omitted here for clarity.

FIG. 12H depicts another example ancillary autonomous vehicle (AV) 1200h. The ancillary AV 1200h may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200h may be coupled with a first or carrier AV and coupled with a payload or package. The ancillary AV 1200h may be further configured to travel between the first or carrier AV and a designated drop target adjacent to a ground or receiving surface at a payload drop location and release the payload at the drop target. Accordingly and as shown in FIG. 12H, the ancillary AV 1200h may include: a body 1204h, a payload release assembly 1208h, a tether attachment assembly 1212h, a tether 1216h, a support section 1220h, an articulation feature 1222h, a control feature 1224h, and a payload 1234h, redundant explanation of which is omitted here for clarity.

FIG. 12I depicts another example ancillary autonomous vehicle (AV) 1200i. The ancillary AV 1200i may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200i may be coupled with a first or carrier AV and coupled with a payload or package. The ancillary AV 1200i may be further configured to travel between the first or carrier AV and a designated drop target adjacent to a ground or receiving surface at a payload drop location and release the payload at the drop target. Accordingly and as shown in FIG. 12I, the ancillary AV 1200i may include: a body 1204i, lights 1206i, a payload release assembly 1208i, a tether attachment assembly 1212i, a tether 1216i, a support section 1220i, a control feature 1224i, and a payload 1234i, redundant explanation of which is omitted here for clarity.

FIGS. 12J and 12K depict another example ancillary autonomous vehicle (AV) 1200j. The ancillary AV 1200j may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200j may be coupled with a first or carrier AV and coupled with a payload or package. The ancillary AV 1200j may be further configured to travel between the first or carrier AV and a designated drop target adjacent to a ground or receiving surface at a payload drop location and release the payload at the drop target. Accordingly and as shown in FIGS. 12J and 12K, the ancillary AV 1200j may include: a body 1204j, lights 1206j, sensors 1207j, a payload release assembly 1208j, a tether attachment assembly 1212j, a tether 1216j, a support section 1220j, a control feature 1224j, a payload 1234j, and a payload coupling portion 1236j, redundant explanation of which is omitted here for clarity. The payload release assembly 1208j may include a window 1209j. When the payload is secured with the ancillary AV 1200j by the payload release assembly, as shown in FIG. 12J, a portion of the payload containing text, such as the text “BRAND”, may appear through the window 1209j. When the payload 1234j is released from the ancillary AV 1200j, as shown in FIG. 12K, the text may remain visible to the customer and by used to identify the items contained therein and/or convey information associated with the payload delivery.

FIG. 12L depicts another example ancillary autonomous vehicle (AV) 1200l. The ancillary AV 1200l may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 12001 may be coupled with a first or carrier AV and coupled with a payload or package. The ancillary AV 1200l may be further configured to travel between the first or carrier AV and a designated drop target adjacent to a ground or receiving surface at a payload drop location and release the payload at the drop target. Accordingly and as shown in FIG. 12L, the ancillary AV 1200l may include: a body 1204l, a payload release assembly 1208l, a tether attachment assembly 1212l, a tether 1216l, a support section 1220l, an articulation feature 1222l, a control feature 1224l, and a payload 1234l, redundant explanation of which is omitted here for clarity.

FIG. 12M depicts another example ancillary autonomous vehicle (AV) 1200m. The ancillary AV 1200m may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200m may be coupled with a first or carrier AV and coupled with a payload or package. The ancillary AV 1200m may be further configured to travel between the first or carrier AV and a designated drop target adjacent to a ground or receiving surface at a payload drop location and release the payload at the drop target. Accordingly and as shown in FIG. 12M, the ancillary AV 1200m may include: a body 1204m, lights 1206m, a payload release assembly 1208m, a tether attachment assembly 1212m, a tether 1216m, a support section 1220m, an articulation feature 1222m, a control feature 1224m, and a payload 1234m, redundant explanation of which is omitted here for clarity.

FIG. 12N depicts another example ancillary autonomous vehicle (AV) 1200n. The ancillary AV 1200n may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200n may be coupled with a first or carrier AV and coupled with a payload or package. The ancillary AV 1200n may be further configured to travel between the first or carrier AV and a designated drop target adjacent to a ground or receiving surface at a payload drop location and release the payload at the drop target. Accordingly and as shown in FIG. 12N, the ancillary AV 1200n may include: a body 1204n, lights 1206n, sensors 1207n, a payload release assembly 1208n, a tether attachment assembly 1212n, a tether 1216n, a support section 1220n, an articulation feature 1222n, a control feature 1224n, and a payload 1234n, redundant explanation of which is omitted here for clarity.

FIG. 12O depicts another example ancillary autonomous vehicle (AV) 1200o. The ancillary AV 1200o may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200o may be coupled with a first or carrier AV and coupled with a payload or package. The ancillary AV 1200o may be further configured to travel between the first or carrier AV and a designated drop target adjacent to a ground or receiving surface at a payload drop location and release the payload at the drop target. Accordingly and as shown in FIG. 12O, the ancillary AV 1200o may include: a body 1204o, lights 1206o, sensors 1207o, a payload release assembly 1208o, a tether attachment assembly 1212o, a tether 1216o, a support section 1220o, an articulation feature 1222o, a control feature 1224o, and a payload 1234o, redundant explanation of which is omitted here for clarity.

FIG. 12P depicts another example ancillary autonomous vehicle (AV) 1200p. The ancillary AV 1200p may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200p may be coupled with a first or carrier AV and coupled with a payload or package. The ancillary AV 1200p may be further configured to travel between the first or carrier AV and a designated drop target adjacent to a ground or receiving surface at a payload drop location and release the payload at the drop target. Accordingly and as shown in FIG. 12P, the ancillary AV 1200p may include: a body 1204p, lights 1206p, sensors 1207p, a payload release assembly 1208p, a tether attachment assembly 1212p, a tether 1216p, a support section 1220p, an articulation feature 1222p, a control feature 1224p, and a payload 1234p, redundant explanation of which is omitted here for clarity.

FIG. 12Q depicts another example ancillary autonomous vehicle (AV) 1200q. The ancillary AV 1200q may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200q may be coupled with a first or carrier AV and coupled with a payload or package. The ancillary AV 1200q may be further configured to travel between the first or carrier AV and a designated drop target adjacent to a ground or receiving surface at a payload drop location and release the payload at the drop target. Accordingly and as shown in FIG. 12Q, the ancillary AV 1200q may include: a body 1204q, sensors 1207q, a payload release assembly 1208q, an articulable release feature 1209q, a tether attachment assembly 1212q, a tether 1216q, a support section 1220q, an articulation feature 1222q, a control feature 1224q, a payload 1234q, and a payload coupling portion 1236q, redundant explanation of which is omitted here for clarity.

FIG. 12R depicts another example ancillary autonomous vehicle (AV) 1200r. The ancillary AV 1200r may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200r may be coupled with a first or carrier AV and coupled with a payload or package. The ancillary AV 1200r may be further configured to travel between the first or carrier AV and a designated drop target adjacent to a ground or receiving surface at a payload drop location and release the payload at the drop target. Accordingly and as shown in FIG. 12R, the ancillary AV 1200r may include: a body 1204r, lights 1206a, a payload release assembly 1208r, a tether attachment assembly 1212r, a tether 1216r, a support section 1220r, an articulation feature 1222r, a control feature 1224r, and a payload 1234r, redundant explanation of which is omitted here for clarity.

FIG. 12S depicts another example ancillary autonomous vehicle (AV) 1200s. The ancillary AV 1200s may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200s may be coupled with a first or carrier AV and coupled with a payload or package. The ancillary AV 1200s may be further configured to travel between the first or carrier AV and a designated drop target adjacent to a ground or receiving surface at a payload drop location and release the payload at the drop target. Accordingly and as shown in FIG. 12S, the ancillary AV 1200s may include: a body 1204s, lights 1206s, a payload release assembly 1208s, an articulable release feature 1209s, a tether attachment assembly 1212s, a tether 1216s, a support section 1220s, a control feature 1224s, a payload 1234s, and a payload coupling portion 1236s, redundant explanation of which is omitted here for clarity.

FIG. 12T depicts another example ancillary autonomous vehicle (AV) 1200t. The ancillary AV 1200t may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200t may be coupled with a first or carrier AV and coupled with a payload or package. The ancillary AV 1200t may be further configured to travel between the first or carrier AV and a designated drop target adjacent to a ground or receiving surface at a payload drop location and release the payload at the drop target. Accordingly and as shown in FIG. 12T, the ancillary AV 1200t may include: a body 1204t, a payload release assembly 1208t, an articulable release feature 1209t, a tether attachment assembly 1212t, a tether 1216t, a support section 1220t, a control feature 1224t, a payload 1234t, and a payload coupling portion 1236t, redundant explanation of which is omitted here for clarity.

FIG. 12U depicts another example ancillary autonomous vehicle (AV) 1200u. The ancillary AV 1200u may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200u may be coupled with a first or carrier AV and coupled with a payload or package. The ancillary AV 1200u may be further configured to travel between the first or carrier AV and a designated drop target adjacent to a ground or receiving surface at a payload drop location and release the payload at the drop target. Accordingly and as shown in FIG. 12U, the ancillary AV 1200u may include: a body 1204u, a payload release assembly 1208u, an articulable release feature 1209u, a tether attachment assembly 1212u, a tether 1216u, a support section 1220u, a control feature 1224u, and a payload 1234u, redundant explanation of which is omitted here for clarity.

FIG. 12V depicts another example ancillary autonomous vehicle (AV) 1200v. The ancillary AV 1200v may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200v may be coupled with a first or carrier AV and coupled with a payload or package. The ancillary AV 1200v may be further configured to travel between the first or carrier AV and a designated drop target adjacent to a ground or receiving surface at a payload drop location and release the payload at the drop target. Accordingly and as shown in FIG. 12V, the ancillary AV 1200v may include: a body 1204v, lights 1206v, a payload release assembly 1208v, an articulable release feature 1209v, a tether attachment assembly 1212v, a tether 1216v, a support section 1220v, an articulation feature 1222v, and a control feature 1224v, redundant explanation of which is omitted here for clarity.

FIG. 12W depicts another example ancillary autonomous vehicle (AV) 1200w. The ancillary AV 1200w may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200w may be coupled with a first or carrier AV and coupled with a payload or package. The ancillary AV 1200w may be further configured to travel between the first or carrier AV and a designated drop target adjacent to a ground or receiving surface at a payload drop location and release the payload at the drop target. Accordingly and as shown in FIG. 12W, the ancillary AV 1200w may include: a body 1204w, lights 1206w, sensors 1207w, a payload release assembly 1208w, a tether attachment assembly 1212w, a tether 1216w, a support section 1220w, an articulation feature 1222w, a control feature 1224w, and a payload 1234w, redundant explanation of which is omitted here for clarity.

FIG. 12X depicts another example ancillary autonomous vehicle (AV) 1200x. The ancillary AV 1200x may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200x may be coupled with a first or carrier AV and coupled with a payload or package. The ancillary AV 1200x may be further configured to travel between the first or carrier AV and a designated drop target adjacent to a ground or receiving surface at a payload drop location and release the payload at the drop target. Accordingly and as shown in FIG. 12X, the ancillary AV 1200x may include: a body 1204x, lights 1206x, a payload release assembly 1208x, a tether attachment assembly 1212x, a tether 1216x, a support section 1220x, an articulation feature 1222x, a control feature 1224x, and a payload 1234x, redundant explanation of which is omitted here for clarity.

FIG. 12Y depicts another example ancillary autonomous vehicle (AV) 1200y. The ancillary AV 1200y may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200y may be coupled with a first or carrier AV and coupled with a payload or package. The ancillary AV 1200y may be further configured to travel between the first or carrier AV and a designated drop target adjacent to a ground or receiving surface at a payload drop location and release the payload at the drop target. Accordingly and as shown in FIG. 12Y, the ancillary AV 1200y may include: a body 1204y, a payload release assembly 1208y, a tether attachment assembly 1212y, a tether 1216y, a support section 1220y, a control feature 1224y, and a control feature 1228y, redundant explanation of which is omitted here for clarity.

FIG. 12Z depicts another example ancillary autonomous vehicle (AV) 1200z. The ancillary AV 1200z may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200z may be coupled with a first or carrier AV and coupled with a payload or package. The ancillary AV 1200z may be further configured to travel between the first or carrier AV and a designated drop target adjacent to a ground or receiving surface at a payload drop location and release the payload at the drop target. Accordingly and as shown in FIG. 12Z, the ancillary AV 1200z may include: a body 1204z, a payload release assembly 1208z, an articulable release feature 1209z, a tether attachment assembly 1212z, a tether 1216z, a support section 1220z, and a control feature 1224z, redundant explanation of which is omitted here for clarity.

FIG. 12AA depicts another example ancillary autonomous vehicle (AV) 1200aa. The ancillary AV 1200aa may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200aa may be coupled with a first or carrier AV and coupled with a payload or package. The ancillary AV 1200aa may be further configured to travel between the first or carrier AV and a designated drop target adjacent to a ground or receiving surface at a payload drop location and release the payload at the drop target. Accordingly and as shown in FIG. 12AA, the ancillary AV 1200aa may include: a body 1204aa, a payload release assembly 1208aa, an articulable release feature 1209aa, a tether attachment assembly 1212aa, a tether 1216aa, a support section 1220aa, and a control feature 1224aa, redundant explanation of which is omitted here for clarity.

FIG. 12AB depicts another example ancillary autonomous vehicle (AV) 1200ab. The ancillary AV 1200ab may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ab may be coupled with a first or carrier AV and coupled with a payload or package. The ancillary AV 1200ab may be further configured to travel between the first or carrier AV and a designated drop target adjacent to a ground or receiving surface at a payload drop location and release the payload at the drop target. Accordingly and as shown in FIG. 12AB, the ancillary AV 1200ab may include: a body 1204ab, lights 1206ab, a payload release assembly 1208ab, an articulable release feature 1209ab, a tether attachment assembly 1212ab, a tether 1216ab, a support section 1220ab, an articulation feature 1222ab, a control feature 1224ab, and a control feature 1228ab, redundant explanation of which is omitted here for clarity.

FIG. 12AC depicts another example ancillary autonomous vehicle (AV) 1200ac. The ancillary AV 1200ac may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ac may be coupled with a first or carrier AV and coupled with a payload or package. The ancillary AV 1200ac may be further configured to travel between the first or carrier AV and a designated drop target adjacent to a ground or receiving surface at a payload drop location and release the payload at the drop target. Accordingly and as shown in FIG. 12AC, the ancillary AV 1200ac may include: a body 1204ac, lights 1206ac, a payload release assembly 1208ac, a tether attachment assembly 1212ac, a tether 1216ac, a support section 1220ac, an articulation feature 1222ac, a control feature 1224ac, and a payload 1234ac, redundant explanation of which is omitted here for clarity.

FIG. 12AD depicts another example ancillary autonomous vehicle (AV) 1200ad. The ancillary AV 1200ad may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ad may be coupled with a first or carrier AV and coupled with a payload or package. The ancillary AV 1200ad may be further configured to travel between the first or carrier AV and a designated drop target adjacent to a ground or receiving surface at a payload drop location and release the payload at the drop target. Accordingly and as shown in FIG. 12AD, the ancillary AV 1200ad may include: a body 1204ad, a payload release assembly 1208ad, a tether attachment assembly 1212ad, a tether 1216ad, a support section 1220ad, an articulation feature 1222ad, a control feature 1224ad, and a payload 1234ad, redundant explanation of which is omitted here for clarity.

FIG. 12AE depicts another example ancillary autonomous vehicle (AV) 1200ae. The ancillary AV 1200ae may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ae may be coupled with a first or carrier AV and coupled with a payload or package. The ancillary AV 1200ae may be further configured to travel between the first or carrier AV and a designated drop target adjacent to a ground or receiving surface at a payload drop location and release the payload at the drop target. Accordingly and as shown in FIG. 12AE, the ancillary AV 1200ae may include: a body 1204ae, a payload release assembly 1208ae, an articulable release feature 1209ae, a support section 1220ae, an articulation feature 1222ae, and a control feature 1224ae, redundant explanation of which is omitted here for clarity.

FIG. 12AF depicts another example ancillary autonomous vehicle (AV) 1200af. The ancillary AV 1200af may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200af may be coupled with a first or carrier AV and coupled with a payload or package. The ancillary AV 1200af may be further configured to travel between the first or carrier AV and a designated drop target adjacent to a ground or receiving surface at a payload drop location and release the payload at the drop target. Accordingly and as shown in FIG. 12AF, the ancillary AV 1200af may include: a body 1204af, lights 1206af, sensors 1207af, a payload release assembly 1208af, a tether attachment assembly 1212af, a tether 1216af, a support section 1220af, a control feature 1224af, and a payload 1234af, redundant explanation of which is omitted here for clarity.

FIG. 12AG depicts another example ancillary autonomous vehicle (AV) 1200ag. The ancillary AV 1200ag may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ag may be coupled with a first or carrier AV and coupled with a payload or package. The ancillary AV 1200ag may be further configured to travel between the first or carrier AV and a designated drop target adjacent to a ground or receiving surface at a payload drop location and release the payload at the drop target. Accordingly and as shown in FIG. 12AG, the ancillary AV 1200ag may include: a body 1204ag, a payload release assembly 1208ag, an articulable release feature 1209ag, a tether attachment assembly 1212ag, a tether 1216ag, a support section 1220ag, a control feature 1224ag, and a payload 1234ag, redundant explanation of which is omitted here for clarity.

FIG. 12AH depicts another example ancillary autonomous vehicle (AV) 1200ah. The ancillary AV 1200ah may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ah may be coupled with a first or carrier AV and coupled with a payload or package. The ancillary AV 1200ah may be further configured to travel between the first or carrier AV and a designated drop target adjacent to a ground or receiving surface at a payload drop location and release the payload at the drop target. Accordingly and as shown in FIG. 12AH, the ancillary AV 1200h may include: a body 1204ah, lights 1206ah, sensors 1207ah, a payload release assembly 1208ah, a tether attachment assembly 1212ah, a tether 1216ah, a support section 1220ah, an articulation feature 1222ah, a control feature 1224ah, and a payload 1234ah, redundant explanation of which is omitted here for clarity.

FIG. 12AI depicts another example ancillary autonomous vehicle (AV) 1200ai. The ancillary AV 1200ai may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ai may be coupled with a first or carrier AV and coupled with a payload or package. The ancillary AV 1200ai may be further configured to travel between the first or carrier AV and a designated drop target adjacent to a ground or receiving surface at a payload drop location and release the payload at the drop target. Accordingly and as shown in FIG. 12AI, the ancillary AV 1200ai may include: a body 1204ai, lights 1206ai, sensors 1207ai, a payload release assembly 1208ai, a tether attachment assembly 1212ai, a tether 1216ai, a support section 1220ai, an articulation feature 1222ai, a control feature 1224ai, and a payload 1234ai, redundant explanation of which is omitted here for clarity.

FIG. 12AJ depicts another example ancillary autonomous vehicle (AV) 1200j. The ancillary AV 1200j may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200j may be coupled with a first or carrier AV and coupled with a payload or package. The ancillary AV 1200j may be further configured to travel between the first or carrier AV and a designated drop target adjacent to a ground or receiving surface at a payload drop location and release the payload at the drop target. Accordingly and as shown in FIG. 12AJ, the ancillary AV 1200aj may include: a body 1204aj, a payload release assembly 1208aj, a tether attachment assembly 1212aj, a tether 1216aj, a support section 1220aj, an articulation feature 1222aj, a control feature 1224aj, a payload 1234aj, and a payload coupling portion 1236aj, redundant explanation of which is omitted here for clarity.

FIG. 12AK depicts another example ancillary autonomous vehicle (AV) 1200ak. The ancillary AV 1200ak may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200ak may be coupled with a first or carrier AV and coupled with a payload or package. The ancillary AV 1200ak may be further configured to travel between the first or carrier AV and a designated drop target adjacent to a ground or receiving surface at a payload drop location and release the payload at the drop target. Accordingly and as shown in FIG. 12AK, the ancillary AV 1200ak may include: a body 1204ak, a payload release assembly 1208ak, a tether attachment assembly 1212ak, a tether 1216ak, a support section 1220ak, a control feature 1224ak, a control feature 1228ak, and a payload 1234ak, redundant explanation of which is omitted here for clarity.

FIG. 12AL depicts another example ancillary autonomous vehicle (AV) 1200al. The ancillary AV 1200al may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200al may be coupled with a first or carrier AV and coupled with a payload or package. The ancillary AV 1200al may be further configured to travel between the first or carrier AV and a designated drop target adjacent to a ground or receiving surface at a payload drop location and release the payload at the drop target. Accordingly and as shown in FIG. 12AL, the ancillary AV 1200al may include: a body 1204al, lights 1206al, sensors 1207al, a payload release assembly 1208al, a tether attachment assembly 1212al, a tether 1216al, a support section 1220al, a control feature 1224al, and a payload 1234al, redundant explanation of which is omitted here for clarity.

FIG. 12AM depicts another example ancillary autonomous vehicle (AV) 1200am. The ancillary AV 1200am may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200am may be coupled with a first or carrier AV and coupled with a payload or package. The ancillary AV 1200am may be further configured to travel between the first or carrier AV and a designated drop target adjacent to a ground or receiving surface at a payload drop location and release the payload at the drop target. Accordingly and as shown in FIG. 12AM, the ancillary AV 1200am may include: a body 1204am, lights 1206am, a payload release assembly 1208am, an articulable release feature 1209am, a tether attachment assembly 1212am, a tether 1216am, a support section 1220am, an articulation feature 1222am, and a control feature 1224am, redundant explanation of which is omitted here for clarity.

FIG. 12AN depicts another example ancillary autonomous vehicle (AV) 1200an. The ancillary AV 1200an may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1200an may be coupled with a first or carrier AV and coupled with a payload or package. The ancillary AV 1200an may be further configured to travel between the first or carrier AV and a designated drop target adjacent to a ground or receiving surface at a payload drop location and release the payload at the drop target. Accordingly and as shown in FIG. 12AN, the ancillary AV 1200an may include: a body 1204an, a payload release assembly 1208an, a tether attachment assembly 1212an, a tether 1216an, a support section 1220an, a control feature 1224an, and a payload 1234an, redundant explanation of which is omitted here for clarity.

FIGS. 13A-13F depict example control assemblies, including various configurations of propellers and sensors of any of autonomous vehicles shown herein. For example, FIG. 13A depicts an example autonomous vehicle (AV) control assembly 1300a. The AV control assembly 1300a may be coupled with a first or carrier AV and/or a second or ancillary AV, such as any of the first of carrier AVs described herein (e.g., first or carrier AVs 300a-300w of FIGS. 3A-3W) and/or any of the second or ancillary AV described herein (e.g., such as the ancillary AVs 1200a-1200an of FIGS. 12A-12AN). The AV control assembly 1300a may be configured to control an orientation, position, direction, rate of travel and so on of the associated respective AV. The AV control assembly 1300a may be further configured to send and receive signals, such as light, data, sound, and/or other appropriate signals that may be used to facilitate the operation of the respective AV.

As shown in FIG. 13A, the AV control assembly 1300a may include: a support structure 1304a, a rotor assembly 1308a, a light source 1312a, and a sensor 1316a. The support structure 1304a may be a structural component of the control assembly 1300a that facilitates the attachment of the control assembly 1300a to a portion of an AV. For example, the support structure 1304a may include a beam, a rod, wing and/or aerodynamic feature that is connected to the AV and operable to support other components of the control assembly 1300a relative to the AV. In some cases, the support structure 1304a may be coupled with an articulation feature of the AV in order to move the control assembly 1300a relative to the AV. The support structure 1304a may further define a cage or housing for the rotor assembly 1308a. The rotor assembly 1308a may be arranged substantially within or otherwise coupled with the support structure 1304a. The rotor assembly 1308a may include one or more airfoils that are configured and generate a lift force. The generated lift force may be used to control an orientation of the AV. The light source 1312a and the sensor 1316a may be provided in order to send and receive information. The light source 1312a, for example, may illuminate in order to provide an indication of the presence of the AV, especially in low lighting conditions. The sensor 1316a, for example, may be used to detect information associated with an environment of the AV, and transmit the detected information to avionics or other systems of the AV.

FIG. 13B depicts another example autonomous vehicle (AV) control assembly 1300b. The AV control assembly 1300b may be substantially analogous to any of the AV control assemblies described herein such as the AV control assembly 1300a of FIG. 13A, and so on. In this regard, the AV control assembly 1300b may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300b may be configured to control an orientation, position, direction, rate of travel and so on of the associated respective AV. The AV control assembly 1300b may be further configured to send and receive signals, such as light, data, sound, and/or other appropriate signals that may be used to facilitate the operation of the respective AV. Accordingly and as shown in FIG. 13B, the AV control assembly 1300b may include: a support structure 1304b, a rotor assembly 1308b, a light source 1312b, and a sensor 1316b, redundant explanation of which is omitted here for clarity.

FIG. 13C depicts another example autonomous vehicle (AV) control assembly 1300c. The AV control assembly 1300c may be substantially analogous to any of the AV control assemblies described herein such as the AV control assembly 1300a of FIG. 13A, and so on. In this regard, the AV control assembly 1300c may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300c may be configured to control an orientation, position, direction, rate of travel and so on of the associated respective AV. The AV control assembly 1300c may be further configured to send and receive signals, such as light, data, sound, and/or other appropriate signals that may be used to facilitate the operation of the respective AV. Accordingly and as shown in FIG. 13C, the AV control assembly 1300c may include: a support structure 1304c, a rotor assembly 1308c, a light source 1312c, and a sensor 1316c, redundant explanation of which is omitted here for clarity.

FIG. 13D depicts another example autonomous vehicle (AV) control assembly 1300d. The AV control assembly 1300d may be substantially analogous to any of the AV control assemblies described herein such as the AV control assembly 1300a of FIG. 13A, and so on. In this regard, the AV control assembly 1300d may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300d may be configured to control an orientation, position, direction, rate of travel and so on of the associated respective AV. The AV control assembly 1300d may be further configured to send and receive signals, such as light, data, sound, and/or other appropriate signals that may be used to facilitate the operation of the respective AV. Accordingly and as shown in FIG. 13D, the AV control assembly 1300d may include: a support structure 1304d, a rotor assembly 1308d, a light source 1312d, and a sensor 1316d, redundant explanation of which is omitted here for clarity.

FIG. 13E depicts another example autonomous vehicle (AV) control assembly 1300e. The AV control assembly 1300e may be substantially analogous to any of the AV control assemblies described herein such as the AV control assembly 1300a of FIG. 13A, and so on. In this regard, the AV control assembly 1300e may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300e may be configured to control an orientation, position, direction, rate of travel and so on of the associated respective AV. The AV control assembly 1300e may be further configured to send and receive signals, such as light, data, sound, and/or other appropriate signals that may be used to facilitate the operation of the respective AV. Accordingly and as shown in FIG. 13E, the AV control assembly 1300e may include: a support structure 1304e, a rotor assembly 1308e, and a light source 1312e, redundant explanation of which is omitted here for clarity.

FIG. 13F depicts another example autonomous vehicle (AV) control assembly 1300f. The AV control assembly 1300f may be substantially analogous to any of the AV control assemblies described herein such as the AV control assembly 1300a of FIG. 13A, and so on. In this regard, the AV control assembly 1300f may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300f may be configured to control an orientation, position, direction, rate of travel and so on of the associated respective AV. The AV control assembly 1300f may be further configured to send and receive signals, such as light, data, sound, and/or other appropriate signals that may be used to facilitate the operation of the respective AV. Accordingly and as shown in FIG. 13F, the AV control assembly 1300f may include: a support structure 1304f, a rotor assembly 1308f, a light source 1312f, and a sensor 1316f, redundant explanation of which is omitted here for clarity.

FIG. 13G depicts another example autonomous vehicle (AV) control assembly 1300g. The AV control assembly 1300g may be substantially analogous to any of the AV control assemblies described herein such as the AV control assembly 1300a of FIG. 13A, and so on. In this regard, the AV control assembly 1300g may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300g may be configured to control an orientation, position, direction, rate of travel and so on of the associated respective AV. The AV control assembly 1300g may be further configured to send and receive signals, such as light, data, sound, and/or other appropriate signals that may be used to facilitate the operation of the respective AV. Accordingly and as shown in FIG. 13G, the AV control assembly 1300g may include: a support structure 1304g, a rotor assembly 1308g, and a light source 1312g, redundant explanation of which is omitted here for clarity.

FIG. 13H depicts another example autonomous vehicle (AV) control assembly 1300h. The AV control assembly 1300h may be substantially analogous to any of the AV control assemblies described herein such as the AV control assembly 1300a of FIG. 13A, and so on. In this regard, the AV control assembly 1300h may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300h may be configured to control an orientation, position, direction, rate of travel and so on of the associated respective AV. The AV control assembly 1300h may be further configured to send and receive signals, such as light, data, sound, and/or other appropriate signals that may be used to facilitate the operation of the respective AV. Accordingly and as shown in FIG. 13H, the AV control assembly 1300h may include: a support structure 1304h and a rotor assembly 1308h, redundant explanation of which is omitted here for clarity.

FIG. 13I depicts another example autonomous vehicle (AV) control assembly 1300i. The AV control assembly 1300i may be substantially analogous to any of the AV control assemblies described herein such as the AV control assembly 1300a of FIG. 13A, and so on. In this regard, the AV control assembly 1300i may be coupled with a first or carrier AV and/or a second or ancillary AV, such as any of the first of carrier AVs described herein (e.g., first or carrier AVs 300a-300w of FIGS. 3A-3W) and any of the second or ancillary AV described herein (e.g., such as the ancillary AVs 1200a-1200an of FIGS. 12A-12AN). The AV control assembly 1300i may be configured to control an orientation, position, direction, rate of travel and so on of the associated respective AV. The AV control assembly 1300i may be further configured to send and receive signals, such as light, data, sound, and/or other appropriate signals that may be used to facilitate the operation of the respective AV. Accordingly and as shown in FIG. 13I, the AV control assembly 1300i may include: a support structure 1304i and a rotor assembly 1308i, redundant explanation of which is omitted here for clarity.

FIG. 14 depicts an example airfoil 1400. The airfoil 1400 may be used with any of the rotor assemblies described herein, such as the rotor assemblies of any of the example carrier AVs of FIGS. 3A-3W, and/or the rotors of any of control features of FIGS. 6A-12AN. In the example of FIG. 14, the airfoil includes an airfoil shape 1404 and lights 1408. In some cases, the airfoil shape 1404 may be optimized for the forward flight of the AV and the hover of the AV. The lights 1408 may be integrated with the airfoil shape in order to provide an indication of the presence of the AV in low lighting conditions.

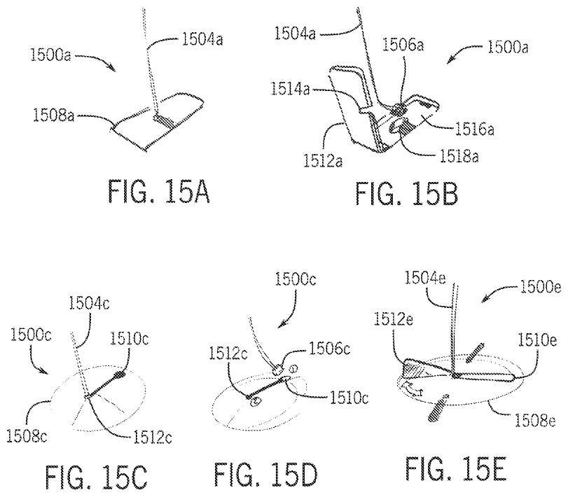

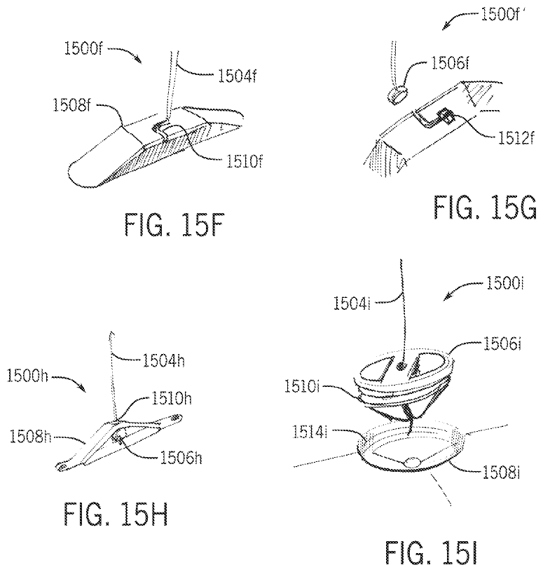

FIGS. 15A-15K depict example tether attachment features. The tether attachment features shown in FIGS. 15A-15K may be substantially analogous to any of the tether attachment features described above with respect to the second or ancillary AVs of FIGS. 6A-12AN. For example, the tether attachment feature may be used to secure a tether to the ancillary AV. In some cases, the tether attachment feature may be configured to releasably couple the tether to the AV in order to release the tether from the ancillary AV for maintenance or replacement of the tether from the AV.

With reference to FIGS. 15A and 15B, a tether attachment feature 1500a is shown. The tether attachment feature 1500a includes a tether 1504a and a coupling mechanism 1508a. The tether 1504a may include an end portion 1506a. The end portion 1506a may be a rigid section that is receivable by the coupling mechanism 1508a in order to restrain movement of the tether 1504a away from the coupling mechanism 1508a. To facilitate the foregoing, the coupling mechanism 1508a may include a first section 1512a and a second section 1516a. The first section 1512a may be foldable relative to the second section 1516a. The first section 1512a may define a passage 1514a that is configured to receive the tether 1504a but that is narrower than a width of the end portion 1506a. The second section 1516a may define a track 1518a that is configured to receive and/or engage the end portion 1506a. In an open configuration, as shown in FIG. 15B, the first section 1512a may be unfolded relative to the second section 1516a such that the end portion 1506a is engaged with the track 1518a and the tether is received through the passages 1514a. In a closed configuration, as shown in FIG. 15A, the first section 1512a may be folded relative to the second section 1516b in order to restrain the end portion 1506a within the coupling mechanism 1508a.

With reference to FIGS. 15C and 15D, a tether attachment feature 1500c is shown. The tether attachment feature 1500c includes a tether 1504c and a coupling mechanism 1508c. The tether 1504c may include an end portion 1506c. The end portion 1506c may be a rigid section that is receivable by the coupling mechanism 1508c in order to restrain movement of the tether 1504c away from the coupling mechanism 1508c. To facilitate the foregoing, the coupling mechanism 1508c may include an opening 1510c and a track 1512c. The opening 1510c may be configured to receive the end portion 1510c. The track 1512c may be configured to receive the tether 1504a and be narrower than a width of the end portion 1506a. In this regard, the end portion 1506c may be received in the opening 1506c, as shown in FIG. 15D. The tether 1504c may be subsequently slid along the track 1512c with the end portion 1506c contained within the coupling mechanism 1508c, as shown in FIG. 15C, in order to restrain the end portion 1506c within the coupling mechanism 1508c.

With reference to FIG. 15E, a tether attachment feature 1500c is shown. The tether attachment feature 1500c includes a tether 1504c and a coupling mechanism 1508c. The tether 1504c may have an end portion that is received in a track 1510e of the coupling mechanism 1508e. The track 1510e may have a tapered width in order to receive the end portion of the tether 1504e at a first end, and progressively narrow in order to constraint the movement of the tether 1504e from the coupling mechanism 1508e. As shown in FIG. 15E, the coupling mechanism 1508e may be rotatable in order to secure the tether 1504e with the coupling mechanism 1508e. For example, the coupling mechanism 1508e may include a tab 1512e that is configured to receive a force that causes the coupling mechanism to rotate in a clockwise and/or counterclockwise manner. In one example, when the coupling mechanism 1508e may be rotated in order to prevent movement of the tether 1504e along the track 1510e.

With reference to FIGS. 15F and 15G, a tether attachment feature 1500f is shown. The tether attachment feature 1500f includes a tether 1504f and a coupling mechanism 1508f. The tether 1504f may include an end portion 1506f. The end portion 1506f may be a rigid section that is receivable by the coupling mechanism 1508f in order to restrain movement of the tether 1504f away from the coupling mechanism 1508f. To facilitate the foregoing, the coupling mechanism 1508f may include an opening 1510f and a track 1512f. The opening 1510f may be configured to receive the end portion 1506f. The track 1512f may be configured to receive the tether 1504f and be narrower than a width of the end portion 1506f. In this regard, the end portion 1506f may be received in the opening 1506f, as shown in FIG. 15G. The tether 1504f may be subsequently slid along the track 1512f with the end portion 1506f contained within the coupling mechanism 1508f, as shown in FIG. 15F, in order to restrain the end portion 1506f within the coupling mechanism 1508f.

With reference to FIG. 15H, a tether attachment feature 1500h is shown. The tether attachment feature 1500h includes a tether 1504h and a coupling mechanism 1508h. The tether 1504h may include an end portion 1506h. The end portion 1506h may be a rigid section that is receivable by the coupling mechanism 1508h in order to restrain movement of the tether 1504h away from the coupling mechanism 1508h. To facilitate the foregoing, the coupling mechanism 1508f may include a raised opening 1510h. The raised opening 1510h may be configured to receive the end portion 1506h in order to restrain the end portion 1506h within the coupling mechanism 1508h.

With reference to FIG. 15I, a tether attachment feature 1500i is shown. The tether attachment feature 1500i includes a tether 1504i and a coupling mechanism 1508i. The tether 1504a may include an end portion 1506i. The end portion 1506i may be a rigid section that is receivable by the coupling mechanism 1508i in order to restrain movement of the tether 1504i away from the coupling mechanism 1508i. In the example of FIG. 15I, the end portion 1506i includes a threaded section 1510i. The coupling mechanism 1508a may include a complimentary threaded section 1514i. As shown in FIG. 15I, the threaded section 1510i may be engaged with the threaded section 1514i in order to restrain the end portion 1506i within the coupling mechanism 1508i.

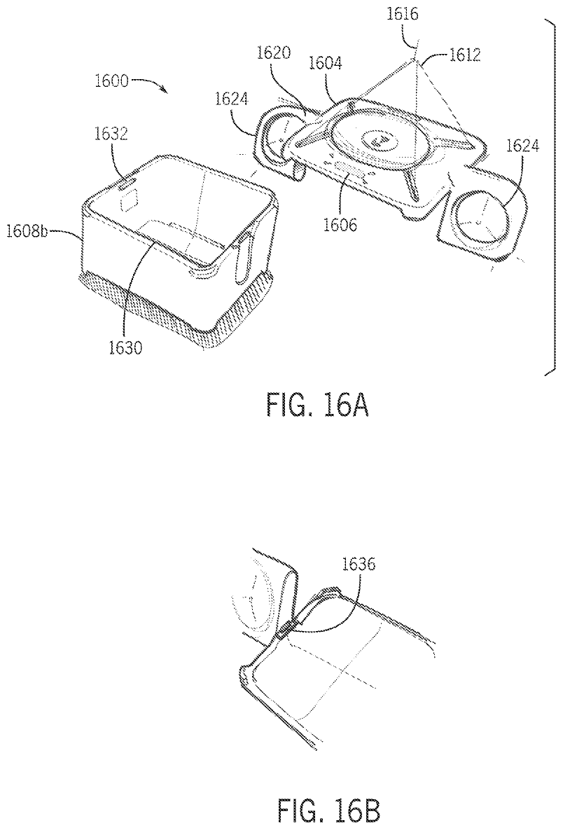

FIGS. 16A and 16B depict a container configuration of any of the second or ancillary autonomous vehicles shown herein. For example, FIGS. 16A and 16B depict example ancillary autonomous vehicle (AV) 1600. The ancillary AV 1600 may be substantially analogous to any of the ancillary AVs or second AVs or the like, described herein, such as the ancillary AV 212 of FIGS. 2A-2D, ancillary AV 600a of FIG. 6A, ancillary AV 1200a of FIG. 12A, and so on. In this regard, the ancillary AV 1600 may be coupled with a first or carrier AV and coupled with a payload or package. The ancillary AV 1600 may be further configured to travel between the first or carrier AV and a designated drop target adjacent to a ground or receiving surface at a payload drop location and release the payload at the drop target. Accordingly and as shown in FIG. 16A, the ancillary AV 1600 may include: a body 1604, lights 1606, a tether attachment assembly 1612, a tether 1616, a support section 1620, and a control feature 1624, redundant explanation of which is omitted here for clarity.

The example of FIGS. 16A and 16B further shows the ancillary AV 1600 as having a container portion 1608. The container portion 1608 may be configured to receive a liner 1630 or other package or feature that is adapted to receive a payload. The container portion 1608 may detach from the body 1604 in order to reveal the liner 1630 to a customer for retrieval of a payload received therein. To facilitate the foregoing, the container portion 1608 may be configured to be removably coupled with the body 1604. For example, the container portion 1608 may include coupling feature 1632, as shown in FIG. 16A. An underside of the body 1604 may in turn include complimentary coupling features 1636. In a secure configuration, the coupling features 1632 and the complimentary coupling features 1636 may engage one another in order to attach the container portion 1608 to the body 1604. The ancillary AV 600a may be in the secure configuration as the ancillary AV 600a travels between the carrier AV and a designated drop target. In a release configuration, the coupling features 1632 and the complimentary coupling features 1636 may disengage from one another in order to separate the container portion 1608 from the body 1604, thereby permitting the customer to retrieve the payload contained therein. In some cases, the customer may subsequently cause the coupling features 1632 and the complimentary coupling features 1636 to reengage one another.

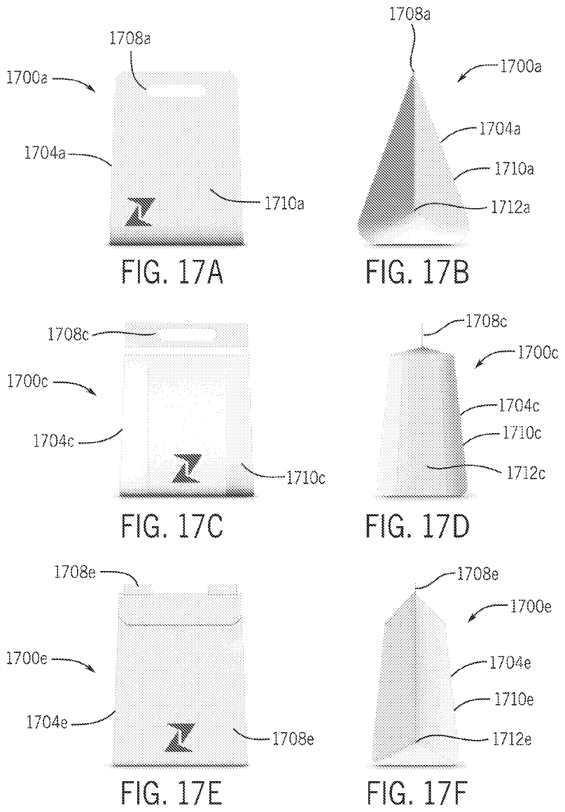

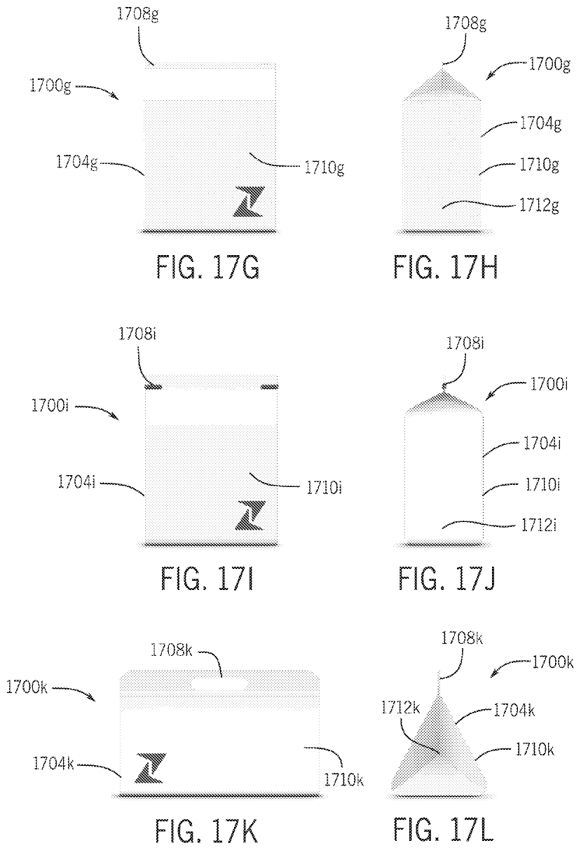

FIGS. 17A-17M depict example packages or payloads of the autonomous vehicle delivery system. For example, FIGS. 17A and 17B depict an example package 1700a. The package 1700a may be substantially analogous to any of the packages described herein. In this regard, the package 1700a may be coupled with a second or ancillary AV, such as any of the second or ancillary AV described herein (e.g., such as the ancillary AVs 1200a-1200an of FIGS. 12A-12AN). The package 1700a may include a payload, including without limitation, a consumer product, medicine or medical items, housewares, food products, and/or other items for delivery to a payload drop location. Accordingly and as shown in FIGS. 17A and 17B, the package 1700a may include: a main portion 1704a, a main portion first side contour 1708a, a main portion second side contour 1710a, and a handle portion 1712a, redundant explanation of which is omitted here for clarity.

FIGS. 17C and 17D depict another example package 1700c. The package 1700c may be substantially analogous to any of the packages described herein such as the package 1700a of FIGS. 17A and 17B, and so on. In this regard, the package 1700c may be coupled with a second or ancillary AV, such as any of the second or ancillary AV described herein (e.g., such as the ancillary AVs 1200a-1200an of FIGS. 12A-12AN). Accordingly and as shown in FIGS. 17C and 17D, the package 1700c may include: a main portion 1704c, a main portion first side contour 1708c, a main portion second side contour 1710c, and a handle portion 1712c, redundant explanation of which is omitted here for clarity.

FIGS. 17E and 17F depict another example package 1700e. The package 1700e may be substantially analogous to any of the packages described herein such as the package 1700a of FIGS. 17A and 17B, and so on. In this regard, the package 1700e may be coupled with a second or ancillary AV, such as any of the second or ancillary AV described herein (e.g., such as the ancillary AVs 1200a-1200an of FIGS. 12A-12AN). Accordingly and as shown in FIGS. 17E and 17F, the package 1700e may include: a main portion 1704e, a main portion first side contour 1708e, a main portion second side contour 1710e, and a handle portion 1712e, redundant explanation of which is omitted here for clarity.

FIGS. 17G and 17H depict another example package 1700g. The package 1700g may be substantially analogous to any of the packages described herein such as the package 1700a of FIGS. 17A and 17B, and so on. In this regard, the package 1700g may be coupled with a second or ancillary AV, such as any of the second or ancillary AV described herein (e.g., such as the ancillary AVs 1200a-1200an of FIGS. 12A-12AN). Accordingly and as shown in FIGS. 17G and 17H, the package 1700g may include: a main portion 1704g, a main portion first side contour 1708g, a main portion second side contour 1710g, and a handle portion 1712g, redundant explanation of which is omitted here for clarity.

FIGS. 171 and 17J depict another example package 1700i. The package 1700i may be substantially analogous to any of the packages described herein such as the package 1700a of FIGS. 17A and 17B, and so on. In this regard, the package 1700i may be coupled with a second or ancillary AV, such as any of the second or ancillary AV described herein (e.g., such as the ancillary AVs 1200a-1200an of FIGS. 12A-12AN). Accordingly and as shown in FIGS. 171 and 17J, the package 1700i may include: a main portion 1704i, a main portion first side contour 1708i, a main portion second side contour 1710i, and a handle portion 1712i, redundant explanation of which is omitted here for clarity.

FIGS. 17K and 17L depict another example package 1700k. The package 1700k may be substantially analogous to any of the packages described herein such as the package 1700a of FIGS. 17A and 17B, and so on. In this regard, the package 1700k may be coupled with a second or ancillary AV, such as any of the second or ancillary AV described herein (e.g., such as the ancillary AVs 1200a-1200an of FIGS. 12A-12AN). Accordingly and as shown in FIGS. 17K and 17L, the package 1700k may include: a main portion 1704k, a main portion first side contour 1708k, a main portion second side contour 1710k, and a handle portion 1712k, redundant explanation of which is omitted here for clarity.

FIGS. 18A-18C depict example implementations of the autonomous vehicle delivery system with existing facilities of various sizes and scales. The autonomous vehicle delivery systems of the present disclosure may be integrated with existing infrastructure of various sizes and configurations. For example, the autonomous vehicle delivery system may be integrated with a relatively small-scale existing infrastructure, such as a small retail location, with a relatively medium-scale existing infrastructure, such as a commercial or wholesale location, and/or with a relatively larger-scale existing infrastructure, such as a large-scale warehouse, distribution, or logistics center, and so on. The autonomous vehicle delivery systems of the present disclosure may be modular systems and may be associated with other systems to form a network and link multiple AV systems together to increase the scale of an integration, as needed.

With reference to FIG. 18A, a system 1800a is depicted. The system 1800a may be illustrative of a relatively small-scale implementation of any of the autonomous vehicle delivery systems described herein. For example, the system 1800a may be used to dock, load, launch, land and perform other associated operations for any of the carrier autonomous vehicles described herein at a relatively small-scale integration, such as a standalone retail location. The small-scale integration may include implementations in which one or two or several autonomous vehicles are used by the associated retail or other location for the delivery of payloads.

To facilitate the foregoing, the system 1800a is shown in FIG. 18A with an autonomous vehicle (AV) docking station 1804a. The AV docking station 1804a may include a raised platform 1808a, a base 1812a, a loading platform 1814a, a charging feature 1816, and a through portion 1820a. The raised platform 1808a may be substantially any surface supported above grade by the base 1812a, such as being substantially any surface supported above a ground surface. The base 1812a is shown in FIG. 18A as being fixed to the grade or the ground surface, such as a parking lot. In other cases, the base 1812b may be part of a mobile installation, such as having wheels and/or being mounted on a trailer. The raised platform 1808a may be configured to receive a carrier AV 1850 and structurally support the carrier AV 1850 above the ground surface. In this regard, the carrier AV 1850 may be configured to land and take off from the raised platform 1808a. The charging feature 1816a may be integrated with the raised platform 1808a. The carrier AV 1850a may be electrically coupled with the charging feature 1816a in order to provide electrical power and/or a data communications link between the carrier AV and the docking station 1804a and/or an external source.

The raised platform 1808a may define the through portion 1820a. The carrier AV 1850a may be received on the raised platform 1808a and positioned substantially over the through portion 1820a. To facilitate loading of a payload, the carrier AV 1850a may release an ancillary AV 1854a through the through portion 1820a. For example, the ancillary AV 1854a may be lowered through the through portion 1820a and onto or adjacent the loading platform 1814a. The ancillary AV 1854a may be loaded with a payload at the loading platform 1814a. In turn, the ancillary AV 1854a may be raised back into the carrier AV 1850, and through the through portion 1820a for loading of the ancillary AV 1854 and payload. In some cases, the ancillary AV 1854a may be configured to dock with the station 1804a while the carrier AV 1850a hovers nearby. The carrier AV may then be pulled toward the station 1804a and into a docking position relative to the station 1854a.

With reference to FIG. 18B, a system 1800b is depicted. The system 1800b is illustrative of a relatively medium-scale implementation of any of the autonomous vehicle delivery systems described herein. For example, the system 1800b may be used to dock, load, launch, land, and perform other associated operations for any of the carrier autonomous vehicles described herein at a relatively medium-scale integration, such as a commercial or wholesale location. The medium-scale integration may include implementations in which several or dozens of autonomous vehicles are used by the associated wholesale or other location for the delivery of payloads.

As shown in FIG. 18B, the system 1800b includes infrastructure 1802b, which may include, without limitation, a commercial or wholesale location. The system 1800b may include a docking station 1804b. The docking station 1804b may be substantially analogous to the docking station described in relation to FIG. 18A, and include: a raised platform 1808b, a loading platform 1814b, a through portion 1820b, a carrier AV 1850b, and an ancillary AV 1854b, redundant explanation of which is omitted here for clarity. In the example of FIG. 18B, additional stations 1806b are provided. The additional stations 1806b may include banks of additional carrier AVs. The additional carrier AV can be readily dispatched to the docking station 1804b via an remote device or other controls 1890b. The additional stations 1806b can be provided in a modular fashion to the system 1800b, allowing the system 1800b to increase and decrease capacity as needed.

With reference to FIG. 18C, a system 1800c is depicted. The system 1800c is illustrative of a relatively large-scale implementation of any of the autonomous vehicle delivery systems described herein. For example, the system 1800c may be used to dock, load, launch, land and perform other associated operations for any of the carrier autonomous vehicles described herein at a relatively large-scale integration, such as a large-scale warehouse, distribution, or logistics center, and so on. The large-scale integration may include implementations in which dozens or hundreds or more autonomous vehicles are used by the associated location for the delivery of payloads.

As shown in FIG. 18C, the system 1800c includes infrastructure 1802c, which may include, without limitation, a large-scale warehouse, distribution, or logistics center. The system 1800c may include a docking station 1804c. The docking station 1804c may be substantially analogous to the docking station described in relation to FIG. 18A, redundant explanation of which is omitted here for clarity. In the example of FIG. 18C, additional docking stations 1806c are provided. The additional stations 1806c may provide additional capacity for loading the AV. In one example, each of the additional stations 1806c may allow for additional AVs to be loaded simultaneously. The additional stations 1806c may be mounted via a trailer or other mobile mechanism in order to add and remove stations as needed. In the example of FIG. 18C, additional AVs 1850c are provided on the roof of the infrastructure 1802c. The additional AVs may be stored on the roof or other location until requested for loading at any of the docking stations of the system 1800c.

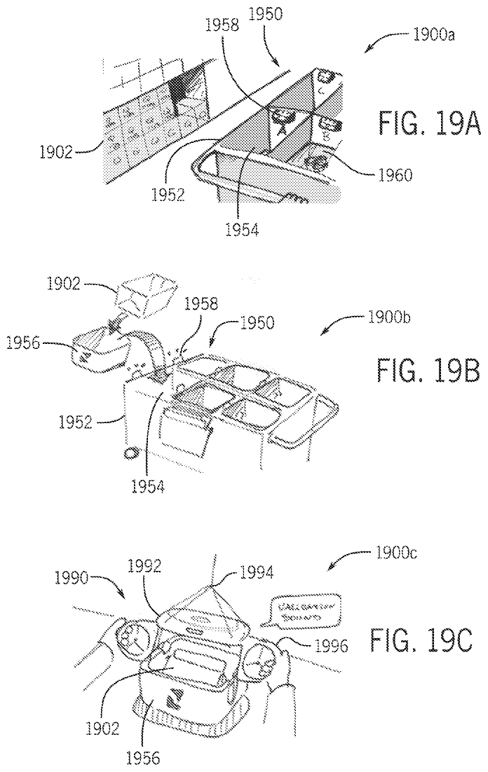

FIGS. 19A-19C depict an example staging system for preparing a payload for delivery by the autonomous vehicle delivery system. The staging system may be used to load a payload or package into the autonomous vehicle. With reference to FIG. 19A, an operation 1900a of the staging system is shown including inventory 1902 and a staging device 1950. The inventory 1902 may include substantially any item capable of delivery by any of the AVs described herein, including without limitation household items, medicines, consumer goods, and so on. The staging device 1950 may be configured to organize the inventory 1902 or other items and determine that the items satisfy a threshold criteria indicative of an acceptable payload. For example, the staging device 1950 may include a loading structure 1952 having receiving zones 1954. Each of the receiving zones 1954 may be associated with an indicator 1954. The receiving zones 1954 may have a bin volume corresponding to a maximum volume that is acceptable for transport for the AV. In this regard, a user may determine that an item or group of items satisfy a size threshold for delivery by fitting the items within a respective one of the receiving zones 1954. Further, each of the receiving zones 1954 may be configured to detect a weight of the items placed therein, such as via a sensor 1960. Where the weight is less than a maximum acceptable weight for transport, the indicator 1954 may emit a signal, such a light or noise, that is indicative of an acceptable payload.

With reference to FIG. 19B, an operation 1900b of the staging system is shown including bins 1956. The bins 1956 may be configured to receive inventory 1902. The receiving zone 1954 may be configured to receive the bins 1956 including the inventory 1902. Upon determination of an acceptable payload (e.g., volume and weight), the bin 1956 may be removed for attachment with an ancillary AV. For example as shown in FIG. 19C, an operation 1900c of the staging system is shown in which the bin 1956 is attached to an ancillary AV 1990. For example, the bin 1956 may be attached to a body 1992 of the ancillary AV 1990. The body 1992 may be attached to a tether attachment system 1994, which couples the ancillary AV 1990 to a carrier AV. Control features 1996 may be provided substantially analogous to the ancillary AVs described above with respect to FIGS. 6A-12AN. As shown in FIG. 19C, the bin 1956 containing the inventory 1902 is couplable with the body 1992. The ancillary AV 1990 including the coupled body 1992 and bin 1956 may be raised and loaded in to a respective carrier AV for delivery of the inventor 1902 to the designated drop target.

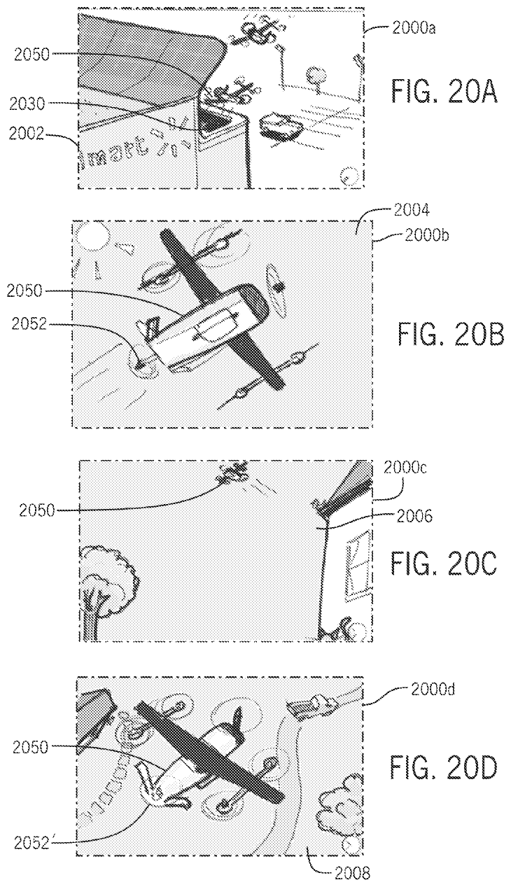

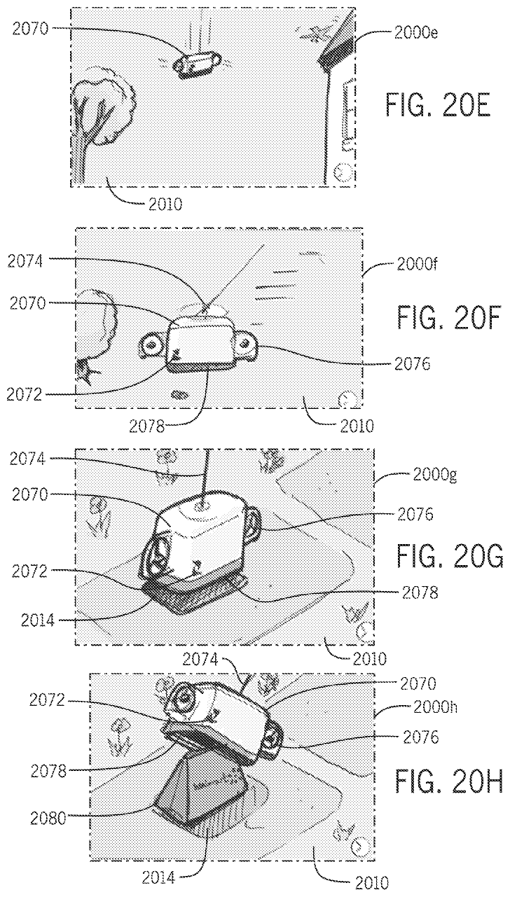

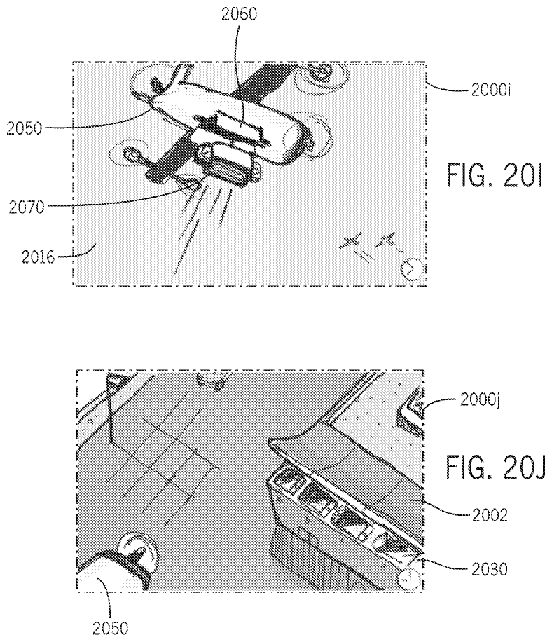

FIGS. 20A-20J depicts example operations of the autonomous vehicle delivery system. With reference to FIG. 20A, an operation 2000a is depicted in which a carrier AV 2050 takes off from an AV station 2030. The AV station 2030 may be integrated with existing infrastructure, as described above with respect to FIGS. 18A-18C. With reference to FIG. 20B, and operation 2000b is depicted in which the carrier AV 2050 travels through an environment 2004 between a payload receiving location and a payload drop location. The carrier AV 2050 may include a rotor assembly 2052 in a first configuration in order to induce the forward flight of the AV 2050. With reference to FIG. 20C, an operation 2000c is depicted in which the carrier AV 2050 approaches a payload drop location 2006. With reference to FIG. 20D, an operation 2000d is depicted in which the carrier AV 2050 transitions to a hover operation at an environment 2008. In the operation 2000d, the carrier AV 2050 transitions the rotor assembly 2052 to a second configuration in order to induce the hover of the AV 2050.

With reference to FIG. 20E, an operation 2000e is shown in which an ancillary AV 2070 descends through an environment 2010. As shown in FIG. 20F, at an operation 2000f, the ancillary AV 2070 may include a body 2072 that is attached to the carrier AV 2050 via a tether attachment assembly 2074. An orientation or position of the ancillary AV 2070 may be controlled or stabilized using one or more control features 2076. A release assembly 2078 may secure a payload or package with the body 2072 during the descent of the ancillary AV 2070 through the environment 2010.

With reference to FIG. 20G, an operation 2000g is shown in which the ancillary AV 2070 arrives at or adjacent a designated drop target 2014. With reference to FIG. 20H, an operation 2000h is shown in which the ancillary AV 2070 manipulates the release assembly 2078 in order to leave a payload 2080 at the designated drop target 2014. With reference to FIG. 20I, an operation 2000i is shown in which the carrier AV 2050 manipulates a release assembly 2060 in order to raise the ancillary AV 2070 back into the carrier AV 2050 in an environment 2016. The carrier AV 2050 may return to the AV station 2030 at operation 2000j, as shown in FIG. 20J.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An autonomous vehicle delivery system configured to deliver a payload or package in a rural and/or urban environment comprising:
a first autonomous vehicle (AV), the first AV configured to travel between a payload receiving location and a payload drop location; and
a second autonomous vehicle (AV) coupled to the first AV, the second AV being coupled to a payload and configured to travel between the first AV and a designated drop target adjacent to a ground or receiving surface at the payload drop location.

2. The AV delivery system of claim 1, wherein
the first AV is configured to release the second AV at the payload drop location, and
the AV delivery system further comprises a retraction assembly configured to return the second AV to the first AV.

3. The AV delivery system of claim 2, wherein the retraction assembly comprises
a tether extending between the first AV and the second AV; and
a winch mechanism coupled to the tether and associated with the first AV or the second AV, wherein the winch mechanism is configured to manipulate the tether and move the second AV and the first AV relative to one another.

4. The AV delivery system of claim 3, further comprising a tether attachment feature configured to fix an end of the tether to the first AV or the second AV.

5. The AV delivery system of claim 3, wherein an orientation of the second AV is controlled by moving the tether relative to a body of the second AV.

6. The AV delivery system of claim 1, wherein the second AV comprises a control feature configured to control movement of the second AV upon release from the first AV including controlling an orientation or position of the second AV relative to the first AV.

7. The AV delivery system of claim 6, wherein the control feature comprises a rotating component, the rotating component configured to influence angular momentum of the second AV during the travel between the first AV and the designated drop target.

8. The AV delivery system of claim 7, wherein the rotating component is fixed relative to a body of the second AV, the rotating component comprising differential thrusters or inertia wheels.

9. The AV delivery system of claim 6, wherein the control feature is fixed relative to a body of the second AV.

10. The AV delivery system of claim 6, wherein the control feature is articulable relative to a body of the second AV, and wherein the control feature comprises active thrusters of open or ducted fan configurations, enclosed air impeller, or compressed gas thrusters.

11. The AV delivery system of claim 6, wherein a landing position of the second AV is controlled in part by modulating a position of the first AV in tandem with motion of the second AV.

12. The AV delivery system of claim 1, wherein the second AV is coupled to a package, the package including the payload.

13. The AV delivery system of claim 1, wherein the second AV comprises a release assembly, wherein the release assembly is configured to:
in a first configuration, hold the package and secure the package with the second AV, and
in a second configuration, cause a disassociation of the package and the second AV at the designated drop target.

14. The AV delivery system of claim 1, wherein the first AV comprises a plurality of deployable members configured to expand with release from a portion of the AV during a hovering operation, wherein the plurality of deployable members are configured to cause a controlled descent of the AV from the hovering operation.

15. The AV delivery system of claim 14, further comprising a fabric portion coupled with the plurality of deployable members to define a canopy shape or aerodynamic maneuvering surfaces configured to cause the controlled descent of the AV from the hovering operation.

16. The AV delivery system of claim 1, wherein the first AV comprises:
a propulsion system coupled with the first AV and comprising a plurality of fixed rotor assemblies and a plurality of tilt rotor assemblies, each tilt rotor assembly of the plurality of tilt rotor assemblies being configured to transition between:
a first configuration in which the tilt rotor assembly has a first orientation to induce a forward flight of the AV, and
a second configuration in which the tilt rotor assembly has a second orientation to induce a hover of the AV.

17. The AV delivery system of claim 1, further comprising an autonomous vehicle (AV) station, the AV station configured to dock the first AV above grade and charge one or more electrical components of the AV.

18. The AV delivery system of claim 17, wherein the AV station is configured to permit lowering of the second AV to allow loading of a payload through manual or automated means.

19. The AV delivery system of claim 18, wherein the second AV is configured to dock with the AV station while the first AV hovers and the first AV is pulled to a docking position relative to the AV station.

20. The AV delivery system of claim 1, further comprising a staging device, the staging device comprising a plurality of bins configured to receive items for transportation by the first AV and determine whether the items satisfy a threshold criteria indicative of an acceptable payload size.
